(19) United States
(12) Patent Application Publication
(10) Pub. No.: US 2013/0069968 A1
(43) Pub. Date: Mar. 21, 2013

(54) METHODS AND APPARATUS FOR HYBRID HALFTONING OF AN IMAGE

(71) Applicants: Jeho Lee, Palo Alto, CA (US); Manu Parmar, Sunnyvale, CA (US); Jennifer Lee Gille, Menlo Park, CA (US)

(72) Inventors: Jeho Lee, Palo Alto, CA (US); Manu Parmar, Sunnyvale, CA (US); Jennifer Lee Gille, Menlo Park, CA (US)

(73) Assignee: QUALCOMM MEMS Technologies, Inc., San Diego, CA (US)

(21) Appl. No.: 13/422,819

(22) Filed: Mar. 16, 2012

Related U.S. Application Data
(60) Provisional application No. 61/535,891, filed on Sep. 16, 2011.

(51) Int. Cl. G09G 5/02

(52) U.S. Cl. 345/582; 345/596

(57) ABSTRACT

This disclosure provides methods, apparatus, and computer programs encoded on computer storage media for tone based halftoning of digital images. By exploiting knowledge of local image features and tone levels, the halftoning method may be adaptively switched between error-diffusion and mask-based dithering with reduced boundary artifacts. By further utilizing a smart quantization error clipping scheme, artifacts inherent to the method of error diffusion are also reduced. The method consistently generates higher quality halftone images for both still and video applications when compared to conventional methods.

### CROSS REFERENCE TO RELATED APPLICATIONS

This application claims priority under 35 U.S.C. Section 119(e) to U.S. Provisional Application 61/535,891, filed on Sep. 16, 2011, entitled “METHODS AND APPARATUS FOR HYBRID HALFTONING OF AN IMAGE,” which is assigned to the assignee hereof. The disclosure of the prior application is considered part of, and is incorporated by reference in, this application.

### TECHNICAL FIELD

This disclosure relates to halftoning methods and apparatus for electronic displays, for example, a display that includes interferometric modulators.

### DESCRIPTION OF THE RELATED TECHNOLOGY

Electromechanical systems (EMS) include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Digital images can be encoded as 24 bits per pixel (bpp) RGB data, which is typically considered to be of a higher bit-depth. However, many image rendering devices (e.g., printers, displays, etc.) have a lower bit-depth, such as bi-level or multi-level with only a few different color or gray levels (for black and white images) per pixel. For instance, many printers can render only 1 bit per channel (3 bpp). Some color reflective displays, for example, analog electromechanical display devices, can render 2 bits per channel (for a total of 6 bpp for three (3) channel colors). Quantizing an input image of a higher bit-depth to render the input image using a lower bit-depth device may lead to many image artifacts (banding, false color, contouring, and so on) appearing in the output image.

To reduce quantization artifacts, a process called halftoning can be used to reduce continuous-tone (or high bit-depth) images to images with a limited number of tone levels (or low bit-depth images). Halftoning is a process that can be used for creating the perception of a continuous-tone color image with a limited number of tone levels by using knowledge of the spatio-chromatic discrimination capabilities of the human visual system.

In general, halftoning methods can be grouped into three categories, namely, iterative methods, error diffusion, and mask-based dithering (or screening). Iterative methods are known to create the highest quality halftone images among methods in the above three categories. However, they may require a great deal of computation and may be impractical for some real-time applications. Since its introduction in 1975 by Floyd and Steinberg, the error diffusion method (for example, Floyd Steinberg Error Diffusion (FSE) has attracted much attention in the graphics community has gained popularity to mitigate quantization issues). The main advantage of FSE is its simplicity and the resulting overall acceptable visual quality of binary images produced by the method. Mask-based dithering or screening requires the least computation among methods in the three categories. Of the three categories, masks generally produce the worst quality halftones.

Error diffusion methods can produce halftone images with smooth texture in slowly varying regions and sharp rendering of image regions with detail. However, error diffusion may also generate some objectionable artifacts (for example, “worms”).

Mask-based dithering is a low complexity method that has been used for many applications. In mask-based dithering, a dither value is determined by modularly addressing a “dither mask” with row and column addresses of the image pixels. The dither value is then added to the input value of each pixel, compared with a fixed threshold and the pixel value is set based on whether the dither value plus the added value is less than or greater than a threshold. Mask-based halftoning methods are pixel-parallel, fast, and simple. In general, however, the halftone images generated by mask based dithering have the lowest image quality due to pattern visibility, noisy appearance (especially in mid-tone areas), inability to reproduce detail, and the limited number of gray levels they can produce.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method for rendering an image on a display, the method including receiving an input image including a plurality of input pixels. For each input pixel, an output pixel is generated by quantizing the input pixel and diffusing the error if the tone of the input pixel is within a tonal range, or if the strength of the edges (strength of high frequency components) within a group of pixels, or a region, associated with or near the input pixel is greater than an edge threshold, and generating an output pixel by dithering the input pixel with a mask if the tone of the input pixel is not within the tonal range and the strength of the edges within a region associated with or near the input pixel is not greater than an edge threshold. Other implementations may also include adding the quantization error resulting from dithering the input pixel with the mask to an error diffusion filter, wherein diffusing the error resulting from quantization of the input pixel is based on the error diffusion filter. Some implementations may generate an output pixel by quantizing the input pixel and diffuse the error using Floyd Steinberg error diffusion. Some implementations may clip the quantization error before adding the error to the diffusion filter.

In some implementations, the region of the input pixel is three pixels by three pixels. In other implementations the region of the input pixel is five pixels by five pixels. In still other implementations, the region of the input pixel is seven pixels by seven pixels.

In some implementations, the region of the input pixel includes less than one percent of the input pixels in the input image. In other implementations, the region associated with or near the input pixel is centered around the input pixel. In some implementations, the region associated with or near the input pixel includes the input pixels within one, two, three, five, seven, nine, or eleven pixels of the input pixel.

Another innovative aspect of the subject matter described in this disclosure can be implemented in a display apparatus, the display apparatus including an electronic display, and a display control module, configured to receive an input image including a plurality of input pixels. For each input pixel, an output pixel is generated by quantizing the input pixel and diffusing the error if the tone of the input pixel is within a tonal range or the strength of the edges within a region of the input pixel is greater than an edge threshold. An output pixel is generated by dithering the input pixel with a mask if the tone of the input pixel is not within the tonal range and the strength of the edges within a region associated with or near the input pixel is not greater than the edge threshold. Each of the generated output pixels is rendered on the electronic display to form a displayed halftone image. Some implementations also include a display, and a processor configured to communicate with the display, the processor being configured to process image data, and a memory device that is configured to communicate with the processor. Still other implementations may also include a driver circuit configured to send at least one signal to the display. Other implementations may include a controller configured to send at least a portion of the image data to the driver circuit. Some implementations may include an image source module configured to send the image data to the processor. In some implementations the image source module includes at least one of a receiver, transceiver, and transmitter. Some implementations may also include an input device configured to receive input data and to communicate the input data to the processor. In some implementations the region associated with or near the input pixel is the input pixels within one, two, three, five, seven, nine, or eleven pixels of the input pixel.

Another innovative aspect of the subject matter described in this disclosure can be implemented as a display apparatus including a means for receiving an input image including a plurality of input pixels. For each pixel, the display apparatus also includes a means for generating an output pixel by quantizing the input pixel and diffusing the error if the tone of the input pixel is within a tonal range or the strength of the edges within a region associated with or near the input pixel is greater than an edge threshold. These implementations also include for each pixel a means for generating an output pixel by dithering the input pixel with a mask if the tone of the input pixel is not within the tonal range and the strength of the edges within a region associated with or near the input pixel is not greater than the edge threshold.

Another innovative aspect of the subject matter described in this disclosure can be implemented as a display apparatus including a means for applying a first halftoning process to a respective input pixel to compute a first halftone pixel, a means for applying a second halftoning process on the respective input pixel to compute a second halftone pixel, and a means for selecting one of the first and the second halftone pixels to generate an output pixel based on local image content in a neighborhood of the respective input pixel.

Another innovative aspect of the subject matter described in this disclosure can be implemented as a method of rendering an image on a display, the method including receiving an input image including a plurality of input pixels, for at least a portion of the plurality of input pixels, determining a quantization error resulting from application of an error diffusion process on the input pixel, and if the quantization error is less than a quantization error threshold, or if an edge strength measurement of a pixel region associated with the input pixel is greater than an edge threshold, generating an output pixel by applying the error diffusion process to the input pixel and diffusing the quantization error. Otherwise, generating an output pixel by dithering the input pixel by adding a noise component to the input pixel.

In some implementations the method may include adding a dithering error resulting from dithering the input pixel by adding the noise component to the input pixel to an error diffusion filter. Diffusing the quantization error resulting from quantization of the input pixel may be based on the error diffusion filter. In some implementations, quantization errors above the quantization error threshold indicate a non-sparse texture and quantization errors below the quantization error threshold indicate a sparse texture.

In some implementations, the quantization error threshold is based, at least in part, on a percentage of the input image bit depth. The quantization error threshold may be between about two percent and three percent of the maximum value of the input pixel. In some implementations, the edge strength measurement filters the region with a Laplacian filter. In some of these implementations, the edge threshold is about six percent of the maximum value of the Laplacian filter. In some implementations, the error diffusion process is Floyd Steinberg error diffusion.

In some other implementations, the dithering error is clipped before adding the dithering error to the diffusion filter. In some implementations, the region associated with the input pixel substantially surrounds the input pixel and includes pixels adjacent to the input pixel. In some implementations, the region of the input pixel includes less than about one percent of the input pixels in the input image.

Another innovative aspect of the subject matter described in this disclosure can be implemented as a display apparatus. The display apparatus includes an electronic display, and a display control module, configured to receive an input image including a plurality of input pixels. Then, for at least a portion of the plurality of the input pixels, the display control module is configured to generate an output pixel by determining a quantization error resulting from application of an error diffusion process on the input pixel. If the quantization error is less than a quantization error threshold, or if an edge strength measurement of a pixel region associated with the input pixel is greater than an edge threshold, the display control module generates an output pixel by applying the error diffusion process to the input pixel and diffusing the quantization error. Otherwise, the display control module generates an output pixel by dithering the input pixel by adding a noise component to the input pixel. The display control module also renders each of the generated output pixels on the electronic display to form a displayed halftone image.

Another innovative aspect includes a display apparatus, including a means for receiving an input image including a plurality of input pixels. for at least a portion of the plurality of input pixels, the display apparatus also includes a means for determining a quantization error resulting from application of an error diffusion process on the input pixel, and a means for generating an output pixel by applying the error diffusion process to the input pixel and diffusing the quantization error if the quantization error is less than a quantization error threshold, or if an edge strength measurement of a pixel region associated with the input pixel is greater than an edge threshold, and a means for generating an output pixel by dithering the input pixel by adding a noise component to the input pixel if the quantization error is greater than the quantization error threshold or the edge strength measurement is less than the edge threshold.

One other innovative aspect disclosed is a non-transitory, computer readable storage medium having instructions stored thereon that cause a processing circuit to perform a method. The method includes receiving an input image including a plurality of input pixels. For at least a portion of the plurality of input pixels, the method also determines a quantization error resulting from application of an error diffusion process on the input pixel. If the quantization error is less than a quantization error threshold, or if an edge strength measurement of a pixel region associated with the input pixel is greater than an edge threshold, the method generates an output pixel by applying the error diffusion process to the input pixel and diffusing the quantization error. Otherwise, the method generates an output pixel by dithering the input pixel by adding a noise component to the input pixel.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIGS. 9A and 9B show a representation of a digital image before and after quantization, respectively.

FIG. 10 is a block diagram illustrating one implementation of an apparatus for rendering an image on an electronic display.

FIG. 11 shows a halftone image 1110 generated by reducing a 24 bpp (8:8:8) image down to 6 bpp (2:2:2) using Floyd Steinberg Error Diffusion (FSE).

FIG. 12 shows the relationship between tone levels, the resulting quantization errors, and the resulting halftone textures.

FIG. 13 is a data flow diagram illustrating one implementation of mask based dithering.

FIG. 14 shows a halftone image 1410 generated by reducing the 24 bpp sRGB (8:8:8) image in FIGS. 9 (a) to 6 bpp (2:2:2) with a 32×32 mask.

FIG. 15 is a conceptual data flow diagram of one implementation of a hybrid halftoning method.

FIG. 16A is a flowchart of one implementation of a method for rendering an image.

FIG. 16B illustrates how an eight (8) bit pixel value may be quantized into two bpp using four quantization levels.

FIG. 16C illustrates sparse zones defined around each quantization level of a 2 bpp image.

FIG. 16D is a flowchart of one implementation of a method for rendering an image.

FIG. 16E is a flowchart of one implementation of a method for rendering an image.

FIG. 17 shows a flowchart illustrating another implementation of hybrid halftoning.

FIGS. 18A-B illustrate tonal ranges for sparse halftone dot zones for (a) one bpp and (b) two bpp, respectively, in some implementations.

FIG. 19 illustrates one implementation of an error clipping scheme that supports bi-level halftoning (1 bit/pixel output) and multi-level halftoning (2 bit/pixel output).

FIG. 20A and FIG. 20B illustrate the benefit of error clipping.

FIG. 21 shows a halftone image generated by reducing the 24 bpp (8:8:8) image in FIG. 9A with hybrid halftoning.

FIGS. 22A-22C illustrate cropped regions of images obtained with the FSE (a), noise based dithering using a dither mask (b), and hybrid halftoning (c), respectively.

FIGS. 23A and 23B show examples of system block diagrams illustrating a display device 40 that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as electromechanical systems (EMS), MEMS and non-MEMS applications), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Various implementations of methods and apparatus that perform hybrid halftoning on an image are disclosed herein. In some implementations of hybrid halftoning, multiple halftoning methods are performed on each input pixel of an image to generate multiple halftone values for the input pixel. After the multiple halftone values are generated, one of the halftone values is selected for the pixel based on the properties of the pixel and its neighboring pixels. In some implementations, at least two halftone values of each input pixel of an image are generated and one of the at least two halftone values is selected to generate an output pixel based on local image content of a neighborhood of the respective input pixel. These methods and apparatus may improve the visual appearance of images rendered by reducing the visual artifacts associated with halftoning as applied in traditional methods.

Particular implementations of the subject matter described in this disclosure can be implemented to realize one or more of the following potential advantages. Visual artifacts introduced by traditional methods can be reduced or eliminated. For example, worm artifacts caused by error diffusion in certain tonal areas can be reduced while the coarse appearance in mid-tone regions caused by mask-based dithering may also be reduced or eliminated. Furthermore, image dithering processing resources and or elapsed time may be reduced for some images. For example, images that utilize halftoning methods that can be performed more quickly or efficiently than traditional error diffusion may require fewer processing resources or less elapsed time to complete the halftoning process. In addition, the visual appearance of images dithered with the disclosed methods may provide an improved visual appearance when compared to images dithered with traditional methods. Some implementations of the hybrid halftoning technique disclosed herein are particularly useful in reducing artifacts in images rendered by a low bit-depth device, such as low bit-depth printers and low bit-depth display devices.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

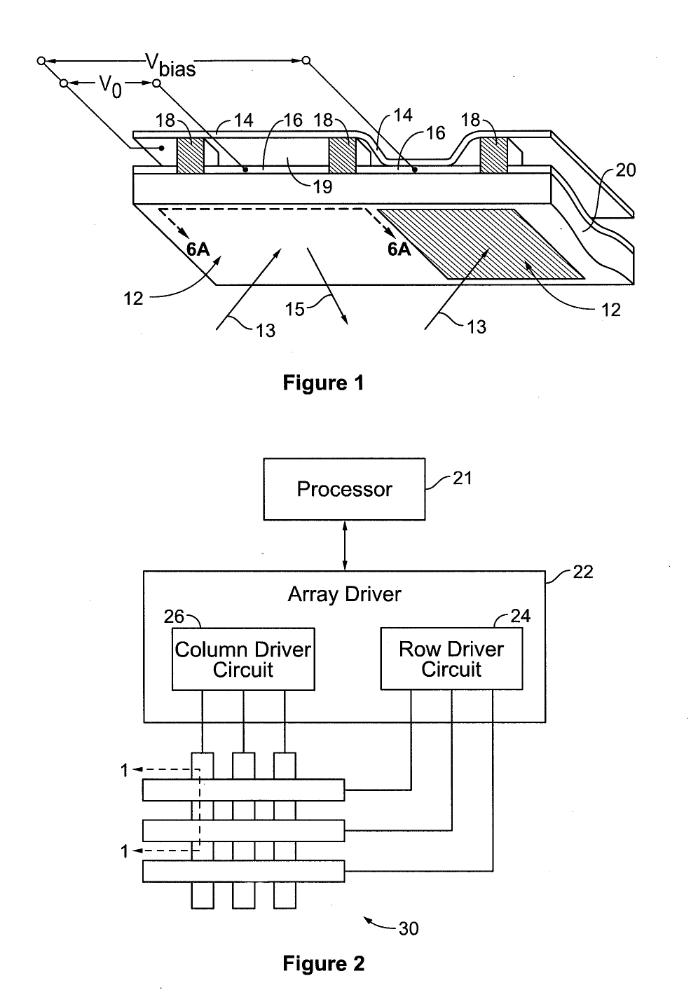

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, absorbing and/or destructively interfering with light within the visible range. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

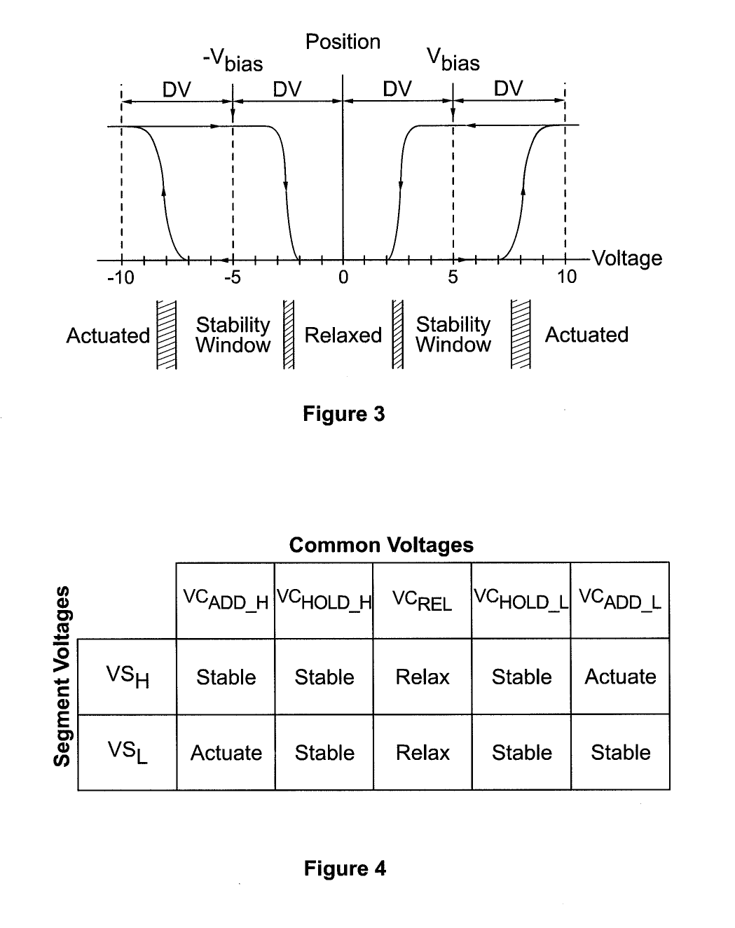

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

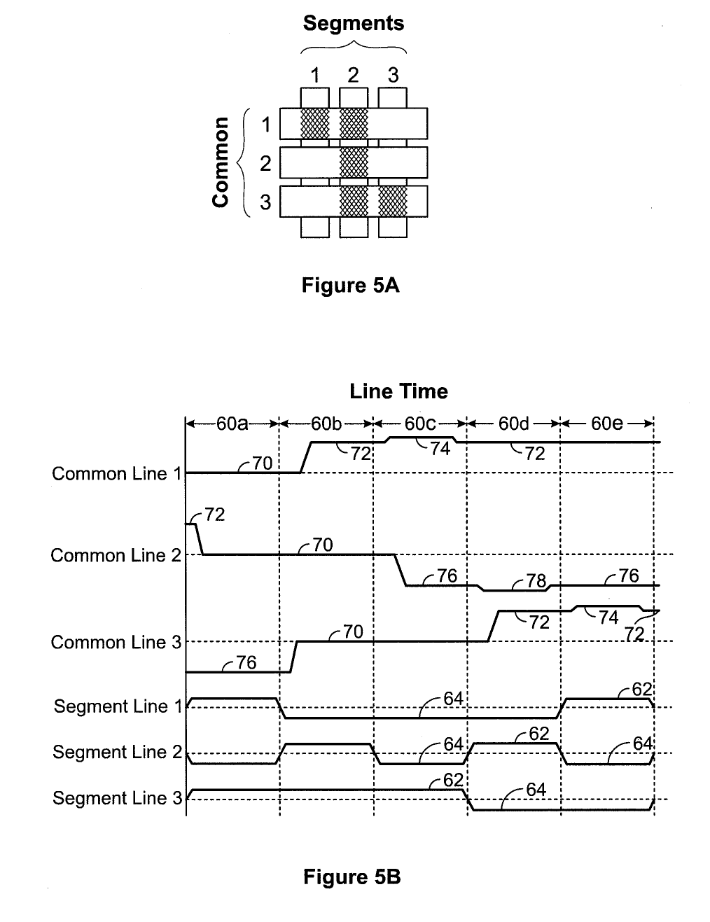

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

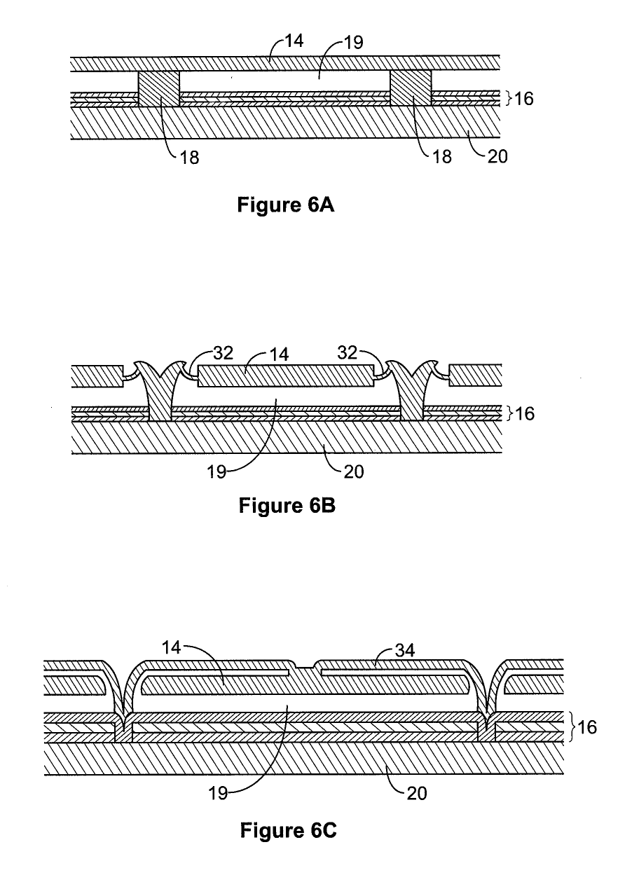

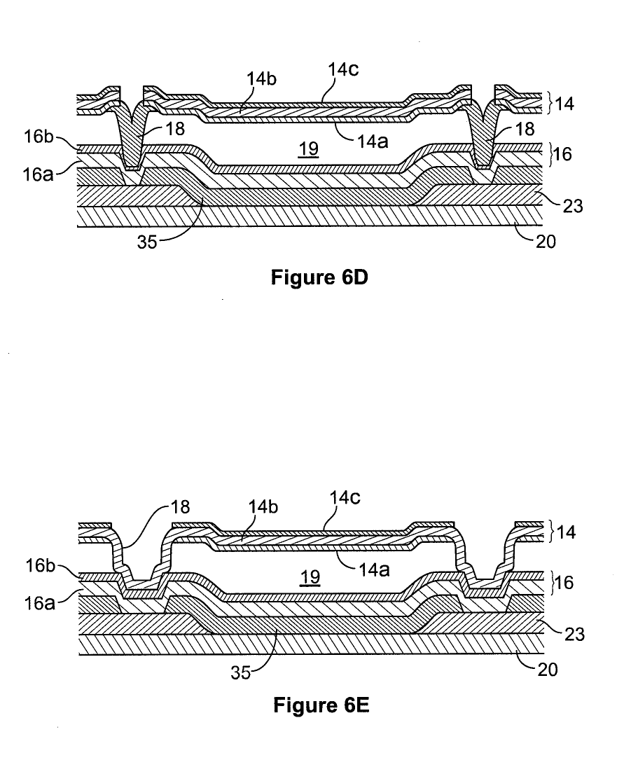

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

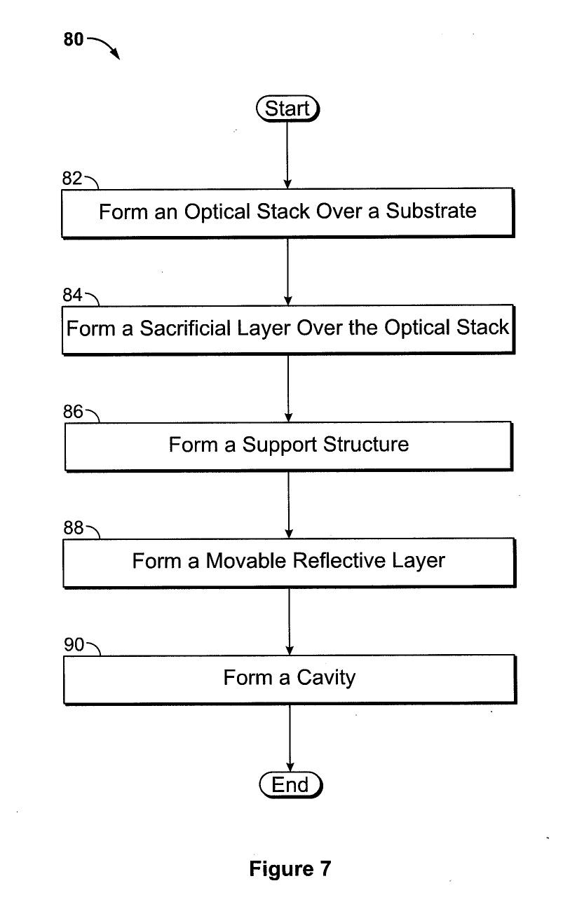

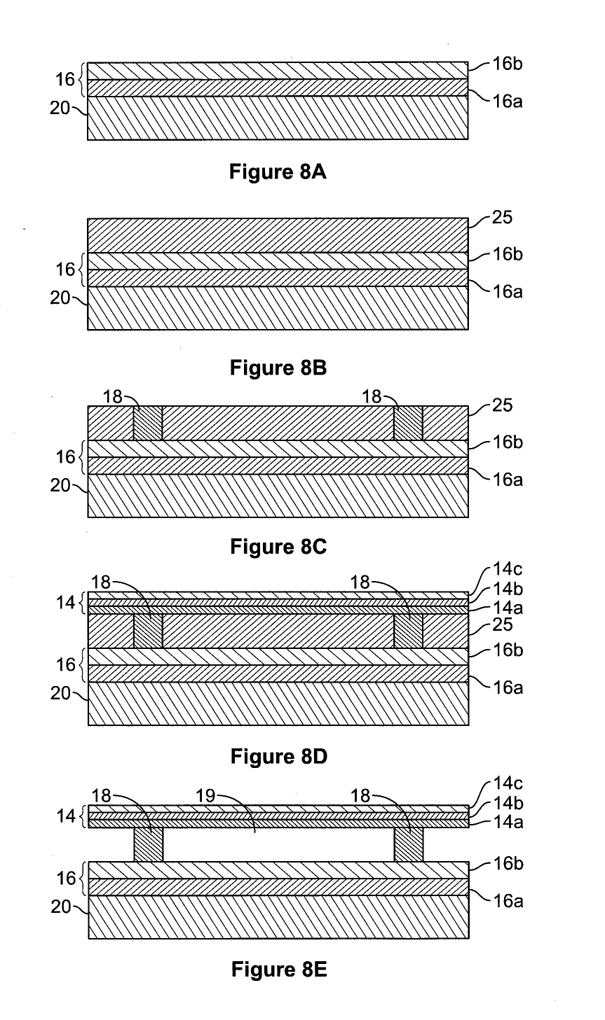

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (e.g., aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

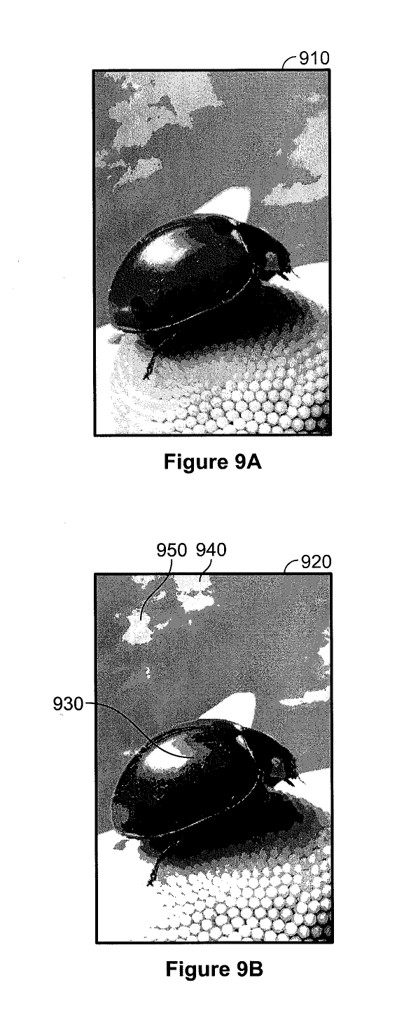

FIGS. 9A and 9B show a representation of a digital image before and after quantization, respectively. FIG. 9A illustrates a 24 bpp RGB image 910. The 24 bpp of the image 910 in FIG. 9A provides 8 bits of information for each of the red, green, and blue colors included in each pixel of the image 910. In order to render the image 910 on a lower bit depth device (e.g., a low bit depth display or printer), the number of bpp of the image 910 may be reduced. FIG. 9B illustrates a six bppbpp image 920 version of image 910 illustrated in FIG. 9A. To produce the image illustrated in FIG. 9B, a quantizing operation drops the six least significant bits (LSBs) from each color channel of the 24 bpp RGB image of FIG. 9A. This quantization process results in two bits of information remaining to represent each of the three colors, i.e., red, green, and blue. Quantization of a digital image such as this may produce many image artifacts, such as banding 930, false color 940, and contouring 950. For example, banding may occur when a region of an image that previously performed a smooth transition from one color to another color instead moves abruptly from one quantization boundary to another.

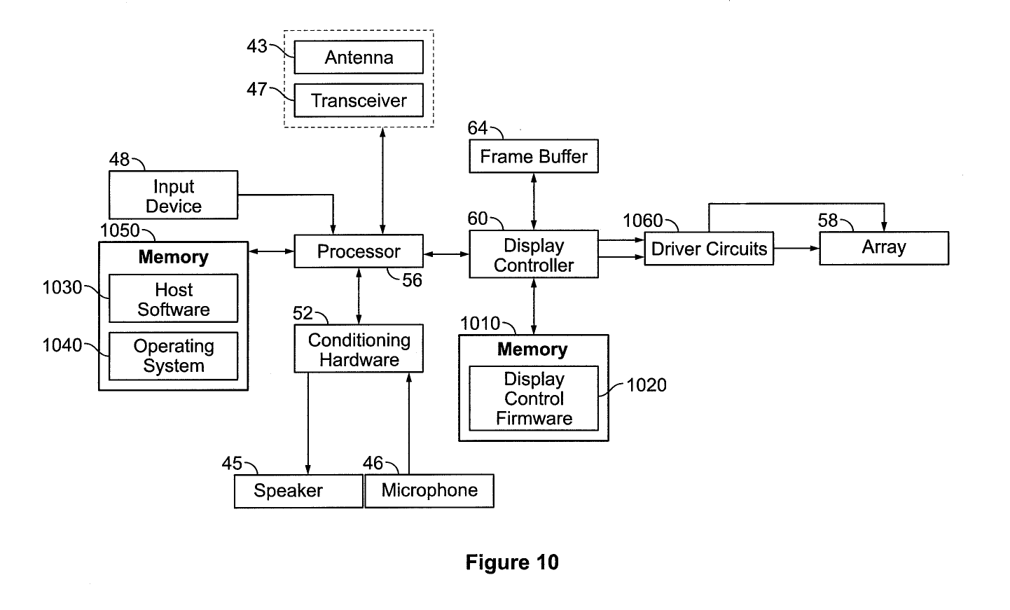

FIG. 10 is a block diagram illustrating one implementation of an apparatus for rendering an image on an electronic display. The apparatus includes a processor 56 in communication with a memory 1050. The memory 1050 includes host software 1030 and operating system 1040. Processor 56 may receive input from an input device 48, and may also be in communication with display controller 60. Display controller 60 is in communication with a frame buffer 64 and a memory 1010. Memory 1010 includes display control firmware 1020.

In some implementations, instructions within operating system 1040 manage the resources of the apparatus to accomplish apparatus functions. For example, operating system 1040 may manage resources such as speaker 45 and microphone 46 via conditioning hardware 52, as well as antenna 43 and transceiver 47. Operating system 1040 may also include display device drivers that manage an electronic display, such as a display controlled by display controller 60. Display controller 60 may be configured to send data to driver circuits 1060, which may write data to an array of display elements 58. A display device driver within operating system 1040 may include instructions that render an image on an electronic display, which may include the array 58, the driver circuits 1060, and the display controller 60.

Operating system 1040 may further include instructions that configure the processor 56 to receive an input image including a plurality of pixels. Therefore, instructions within operating system 1040 may represent one way for receiving an input image including a plurality of pixels.

Instructions within operating system 1040 may also configure processor 56 to determine if the tone of an individual input pixel is within a particular tonal range. Therefore, instructions within operating system 1040 represent one way for determining if an input pixel is within a tonal range. Instructions within operating system 1040 may also configure processor 56 to determine if the strength of the edges within a group of pixels or region associated with or near the input pixel is greater than an edge threshold. Therefore, instructions within operating system 1040 represent one way for determining if the strength of the edges within a group of pixels or region associated with or near the input pixel is greater than an edge threshold. Instructions within operating system 1040, when executed by processor 56, may also cause processor 56 to generate an output pixel by dithering the input pixel. The input pixel may be dithered using a dither mask in some implementations. In some other implementations, a noise component may be added to the input pixel to dither it. For example, a randomized noise component may be added to the input pixel. Instructions within operating system 1040, when executed by the processor 56, may also cause the processor 56 to generate an output pixel by quantizing the input pixel and diffusing the error.

In other implementations, the functions described above as included in operating system 1040 may instead be included in host software 1030, illustrated in FIG. 10. Alternatively, these functions may instead be implemented by instructions included in display control firmware 1020. In still other implementations, these functions may be implemented in special purpose circuits. One having ordinary skill in the art would recognize other implementations may vary from the block diagram of FIG. 10 without departing from the spirit of the methods disclosed.

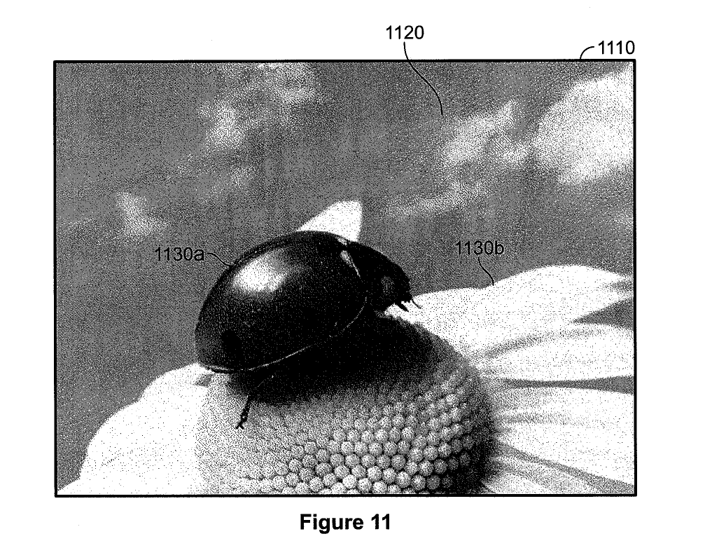

FIG. 11 shows a halftone image 1110 generated by reducing a 24 bpp (8:8:8) image down to 6 bpp (2:2:2) using Floyd Steinberg Error Diffusion (FSE). As illustrated in image 1110, the error diffusion method renders very smooth and fine textures for some areas in the image, when compared to the image 920 of FIG. 9B. The error diffusion method also preserves edges 1130a-b well and the halftone image 1110 may appear crisp and sharp overall. However, in some areas of the image, e.g., the sky, error diffusion creates directional artifacts such as wormy patterns 1120. Directional artifacts 1120 may appear when the halftone texture produced for an image region is sparse.

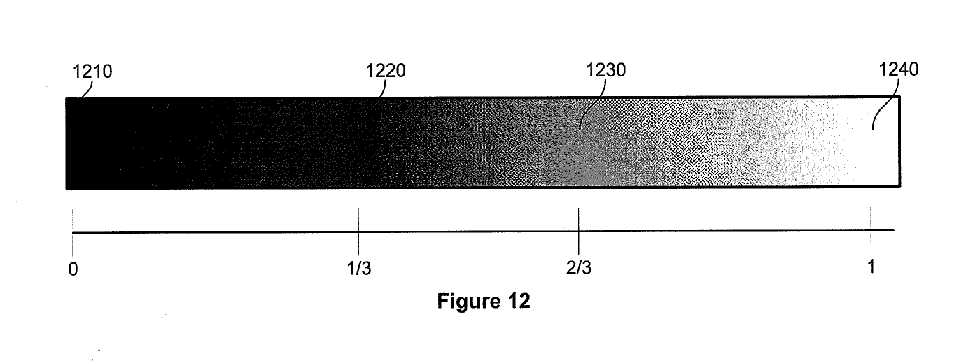

FIG. 12 shows the relationship between tone levels, the resulting quantization errors, and the resulting halftone textures. In general, directional artifacts occur when the input tone level is close to a quantization level, since smaller quantization errors produce sparser halftone textures. For instance, in the case of bi-level halftoning, which produces output pixel values of 0 or 1, if the input pixel value is very low, near black 1210, or high-tone, near white 1240, the resulting halftone texture will be very sparse, as can be seen in FIG. 12. With multilevel halftoning, for example with quantization values of 0, 1/3, 2/3, and 1 in the 2-bit, 4-level case, an input pixel value near any of these levels may result in a sparse halftone texture.

FIG. 12 shows the quantization of an input image from black to white (also referred to as “gray ramp”) at 2 bpp using FSE. In this implementation, worm patterns appear around intensity levels of 0 1210, 1/3 1220, 2/3 1230, and 1 1240 are noticeable. This illustrates that FSE can perform differently near tone levels where quantization errors are low. The disclosed hybrid halftoning methods address artifacts in such areas by using a different halftoning method for input tone-levels susceptible to artifacts with FSE. One such method is dithering by adding noise to the input pixel. Some implementations add noise to an input pixel using a dither mask.

When the number of tone levels used in a displayed image are reduced by quantization, artifacts, such as contouring, may appear as the error becomes correlated with the input image. Decorrelating error from input image values may mitigate such effects. Adding noise before quantization may achieve this by correlating the quantization error with the more random noise instead of the less random image signal. The noise can be designed with desirable properties, for example, with more high frequency content (which is less perceivable by the human eye) to appropriately shape the quantization error. This method may be used in some implementations of dither-mask based halftoning.

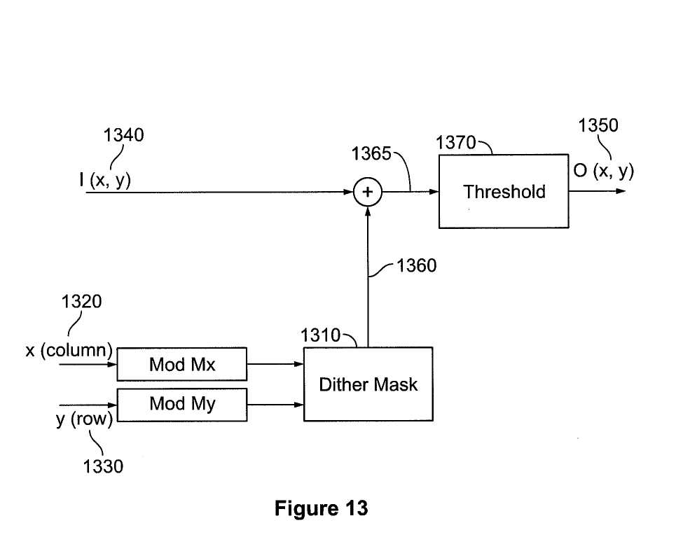

FIG. 13 is a data flow diagram illustrating one implementation of mask based dithering. The dither mask 1310 includes elements that may be randomly distributed across the range of expected input values. In some implementations, the mask is tiled across an image to provide a correspondence between image pixel values and elements of the dither mask. In other implementations, a dither value for a particular pixel may be determined by modularly addressing the dither mask 1310 with row 1330 and column 1320 addresses of the image pixels.

Once a correspondence is established between an element of the dither mask and the input value 1340, the dither value 1360 is then added to the input value 1340 to produce combined value 1365. This combined value is then compared with a fixed threshold 1370 or series of thresholds in the case of multilevel halftoning.

If the combined value 1365 is below a threshold, the output value 1350 may be set to the lower boundary value below the threshold. For example, if dithering between output values of 0 and 1 (representing pixels that are “off” and “on”), a combined value 1365 below a threshold of 0.5 may result in an output value 1350 of zero (0) or “off” If the combined value 1365 is above the threshold, the output value 1350 may be set to a higher boundary value. In the previous example, the output value may be set to a value of one (1) or “on.” Therefore, the output value 1350 is produced based on combined value 1365's relationship to the one or more thresholds.

Mask-based halftoning methods are pixel-parallel, fast, and simple. In general, however, the halftone images from mask-based dithering have the lowest image quality due to pattern visibility, noisy appearance (especially in mid-tone areas), an inability to reproduce detail, and the limited number of gray levels which can be produced.

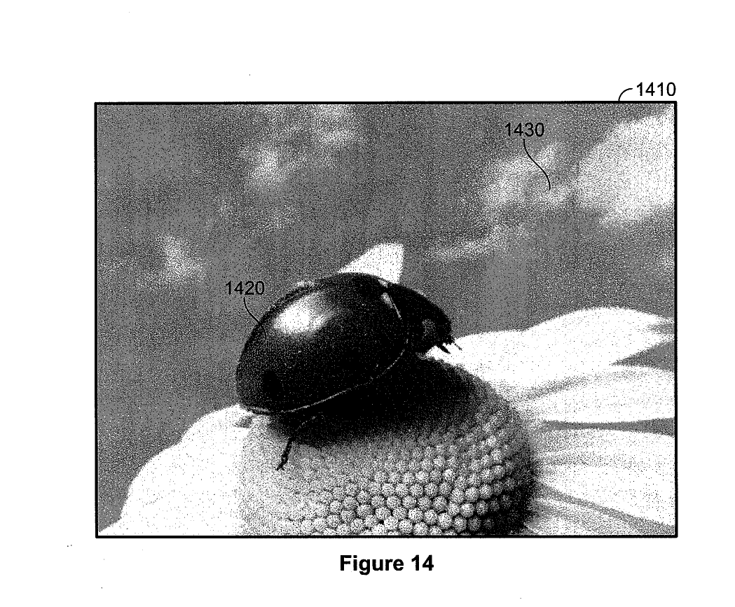

FIG. 14 shows a halftone image 1410 generated by reducing the 24 bpp standard RGB (sRGB) (8:8:8) image in FIG. 9A to 6 bpp (2:2:2) with a 32×32 mask. The halftoned image appears dull, flat, and noisy. For example, graininess can be observed on the lady bug's back 1420. However, the sky 1430 is rendered much more uniformly compared to result of using FSE. Because of this worm-free halftone texture, mask-based dithering (also known as screens) may be favored over error diffusion in some still image applications.

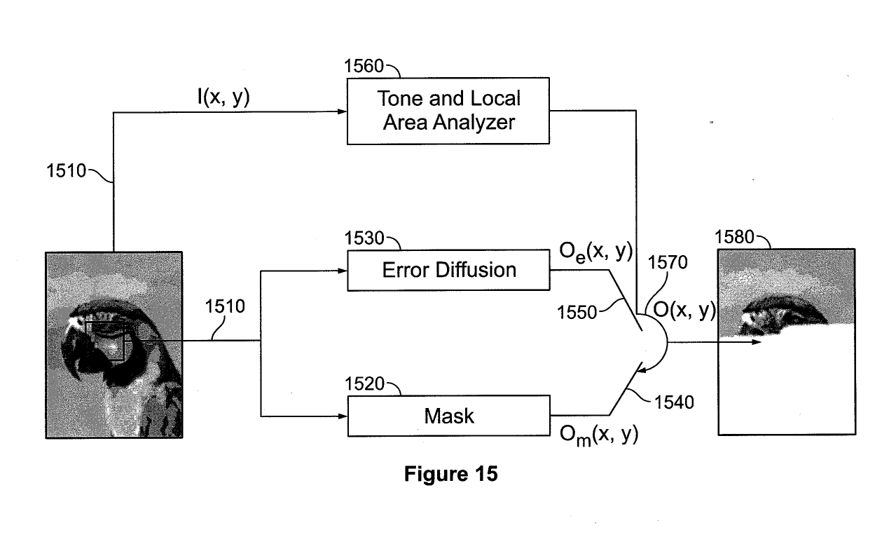

FIG. 15 is a conceptual data flow diagram of one implementation of a hybrid halftoning method. In one implementation, this method may be implemented by instructions contained in operating system module 1040, host software module 1030, display controller 60, or display control firmware module 1020 of FIG. 10. Hybrid halftoning may generate high quality halftone images by removing artifacts introduced by conventional methods, including visible worm artifacts in certain tone areas (e.g., caused by FSE) and coarse appearance in mid-tone areas (e.g., caused by mask-based dithering). However, hybrid halftoning may retain benefits of these methods. For example, the sharp and fine rendering provided by FSE may be retained, and the uniform textures in low dot density areas provided by mask-based dithering may also be retained. To accomplish this, some implementations of hybrid halftoning switch between error diffusion and random noise dithering based on the input tone and image features that are in a local area. These implementations may also reduce boundary artifacts between halftone pixels processed with the different methods by combining and distributing the quantization error incurred by both methods.

As FIG. 15 illustrates, for a given pixel 1510 at (x, y), the method applies a dither mask 1520 and generates the output halftone pixel Oₘ(x, y) 1540. The method also generates the halftone pixel Oₑ(x, y) 1550 by applying error diffusion via processing block 1530 to input pixel value 1510. In some implementations, both error diffusion and mask-based dithering are performed substantially simultaneously. This produces two candidates for the final halftone pixel at (x, y), namely, Oₘ(x, y) 1540 and Oₑ(x, y) 1550. In some implementations, the method analyzes the input tone as well as spatial frequency content of a group of at least four pixels via processing block 1560 to determine which halftoning method is more appropriate for the given pixel. The group of at least four pixels may be non-contiguous within the image. The group of at least four pixels may also include a region near the input pixel or associated with the input pixel. Switch 1570 may then select either the error diffused pixel value 1550 or the mask-based dithered pixel value 1540 for the halftoned image 1580. Note that in some implementations, a dither mask may not be used to dither the input pixel 1540. For example, these implementations may instead select a noise component to add to the input pixel by techniques other than a dither mask. For example, a random noise component may be generated for each pixel in these implementations.

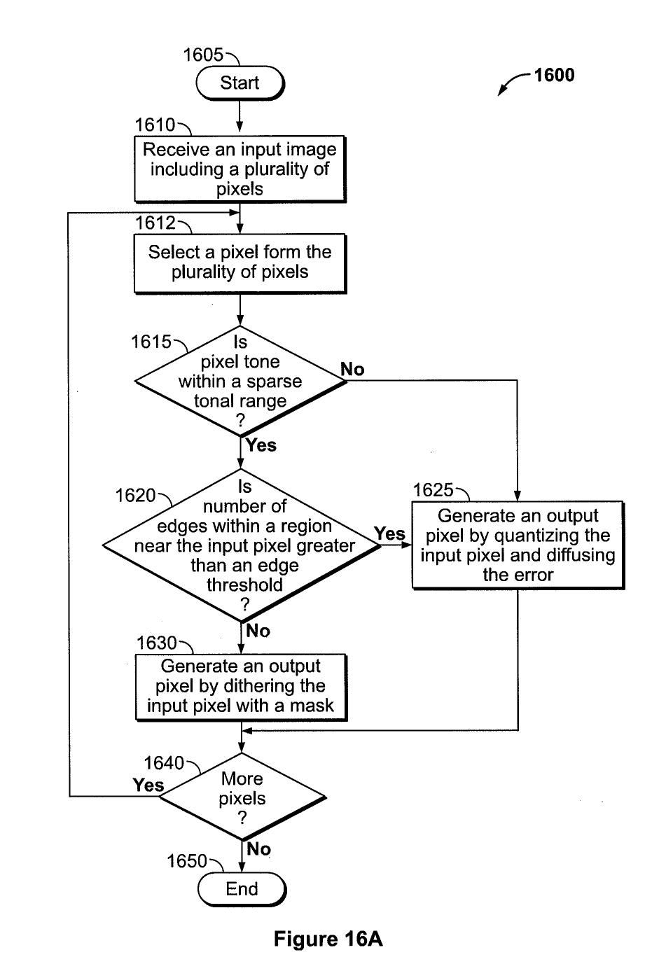

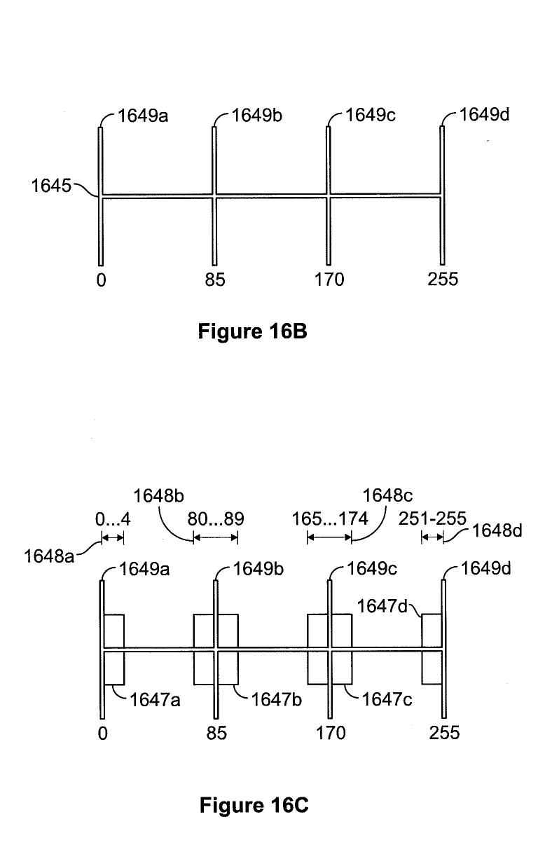

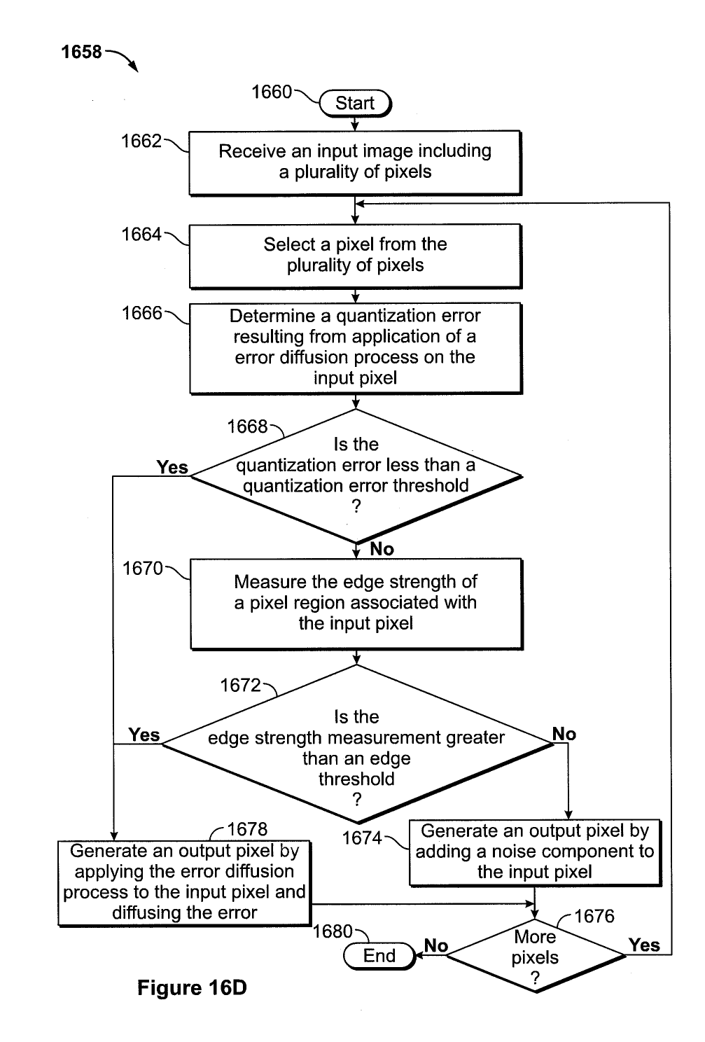

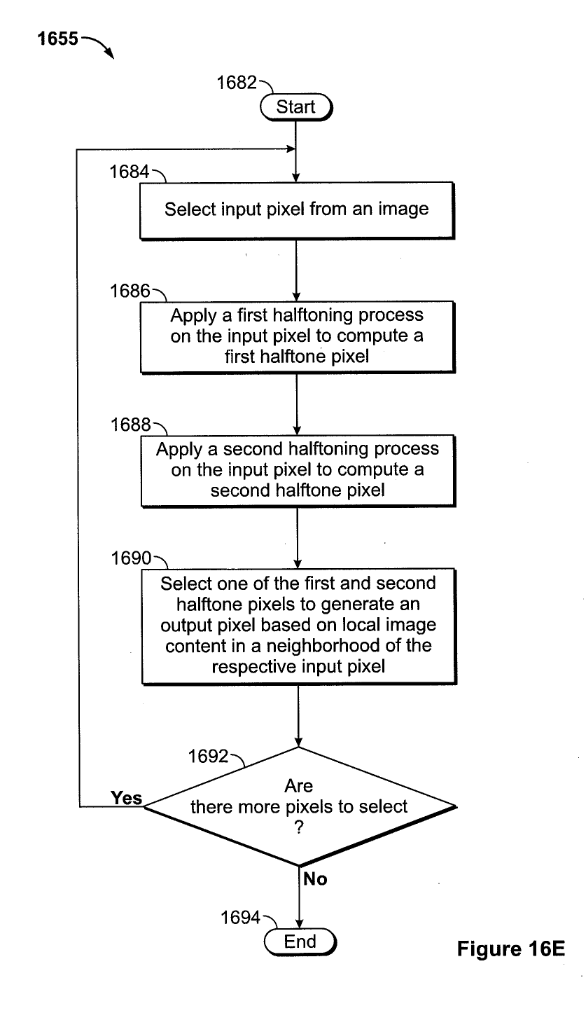

FIG. 16A is a flowchart of one implementation of a method for rendering an image. Process 1600 may be performed in one implementation by instructions contained in operating system module 1040, host software module 1030, display controller 60, or display control firmware module 1020 of FIG. 10. Process 1600 begins at start block 1605 and then moves to block 1610, where an input image is received that includes a plurality of pixels. Block 1610 may be implemented by instructions included in, for example, the host software module 1030, operating system 1040, display control firmware 1020, or display controller 60 of FIG. 10. The input image may be received, in some implementations from the input device 48 of FIG. 10. Therefore, instructions included in host software module 1030, operating system 1040, display control firmware 1020, or display controller 60, executing on a processor, such as processor 56 in FIG. 10, may represent one way to receive an input image including a plurality of input pixels.

Process 1600 then moves to block 1612, where a pixel is selected from the plurality of pixels. Process 1600 then moves to block 1615, where it determines whether a particular input pixel's tone is within a sparse tonal range. Sparse tone-levels are susceptible to worm artifacts with FSE. A tonal range may determine whether a pixel is within a sparse tonal range. If the tone of the pixel is within the sparse tonal range, then the pixel is considered to have a sparse tone. Otherwise the pixel is considered to have a non-sparse tone.

The sparseness of a pixel may represent the proximity of the pixel's tonal value to a quantization level. A first pixel may have a value that is a first distance from a quantization level. This first pixel may have a sparser tone than a second pixel having a value further from a quantization level than the first pixel's value.

FIG. 16B illustrates how an eight (8) bit pixel value range 1645 may be quantized into two bpp using four quantization levels 1649a-d. As shown, the pixel values after quantization will represent tonal values of 0 (0x00), 85 (0x01), 170 (0x10), and 255 (0x11). The relative closeness of a particular input pixel's tonal value to any of these quantization levels corresponds to the sparseness of the half tone pattern used to dither this value.

FIG. 16C illustrates sparse zones 1647a-d defined around each quantization level of an 8 bpp image. The size or width of the sparse zones may be determined based on a percentage of the bit depth of the image being quantized. For example, an eight (8) bpp image has a maximum value of 255. A percentage of this value may be used to define the size or width of the sparse zone around each quantization level. For example, one implementation may choose to define a sparse zone with a width equal to about four (4) percent of the maximum pixel value. In the case of an eight (8) bpp image, four percent of the maximum value of an eight bit pixel (255) is approximately ten (10).

In some implementations, the sparse zones define a range of input pixel values extending from each quantization level. In the example above, a sparse zone of ten (10) pixels may define sparse zones extending 10/2 or five pixel values from each quantization level and in each direction. With two bpp quantization, the sparse zones would then be defined as illustrated in FIG. 16C, items 1648a-d. FIG. 16C shows ten pixel wide ranges surrounding quantization levels 1649b and 1649c, corresponding to quantization values 85 and 170. Because quantization levels 1649a (representing a value of zero (0)) and 1649d (representing a value of 255) bound the pixel range, the sparse region extends from one side of these quantization levels. Other implementations may choose to define a sparse zone as 2, 3, 5, 6, 7, 8, or 9 percent of the maximum pixel value.

When quantizing to one bpp, a different percentage of the maximum pixel value may be used. For example, the sparse zone of a one bpp quantization may include a higher percentage of the maximum pixel value than a sparse zone of a two bpp quantization. Quantization of larger bit depth images may use percentages of maximum pixel values that are similar to the percentages used for eight (8) bpp images. For example, a 16 bit image quantized into two bpp may select a tonal range that is four (4) percent of its maximum pixel value. In this example, this represents a tonal range of 1310 pixel values. Generally, these ranges would extend 1310/2 or 655 pixel values from each quantization level and in each direction.

Returning to the discussion of FIG. 16A and decision block 1615, if the tone of the input pixel is not within a sparse tonal range, then the pixel is less susceptible to the artifacts associated with traditional error diffusion. Process 1600 then moves to processing block 1625, where an output pixel is generated by quantizing the input pixel and diffusing the error. Block 1625 may also be implemented by instructions included in the host software 1030, operating system 1040, display control firmware 1020, or display controller 60, illustrated in FIG. 10. Therefore, these instructions, executing on a processor such as processor 56 in FIG. 10 represent one way to generate an output pixel by quantizing the input pixel and diffusing the error.

If the input pixel is within the sparse tonal range, then the pixel may be susceptible to error diffusion artifacts. To further understand the nature of the input pixel when it is in a sparse tonal range, process 1600 moves from decision block 1615 to decision block 1620, where the strength of the edges within a region near the input pixel is measured and compared to an edge threshold. The region near or associated with the input pixel may be a group of at least four contiguous or non-contiguous pixels. A region near an input pixel may also be associated with the input pixel by the methods disclosed. For example, the methods disclosed may determine how to dither the input pixel based, at least in part, on the values of a group of at least four pixels. These pixel values may also be within the region near or associated with the input pixel.

If the strength measurement of the edges within the region is greater than the edge threshold, the region around the input pixel is characterized as sufficiently non-uniform. In some implementations, the strength of the edges may be measured based, at least in part, on the output of a Laplacian filter. For example, a 3×3 Laplacian filter may be used. Other Laplacian filter sizes may also be used, for example, 5×5, 7×7, and 9×9 filters may be used. If the output of the filter is above an edge threshold, the pixel region or group considered by the Laplacian filter is considered to include edge components sufficient to avoid image artifacts if error diffusion is used.

Tables 1, 2, and 3 below show some examples of Laplacian filters that may be used to determine the strength of edge components of a region or group of pixels of an image in some implementations.

TABLE 1

| | | |
|---|---|---|
| 1 | 1 | 1 |
| 1 | −8 | 1 |
| 1 | 1 | 1 |

TABLE 2

| | | |
|---|---|---|
| 0 | 1 | 0 |
| 1 | −4 | 1 |
| 0 | 1 | 0 |

TABLE 3

| | | |
|---|---|---|
| .5 | 1 | .5 |
| 1 | −6 | 1 |
| .5 | 1 | .5 |

An edge threshold for these filters may be determined based on the maximum absolute value of the filters. For purposes of illustration, we assume an implementation utilizing eight (8) bpp, with black pixels represented by a value of 255 and white pixels represented by a value of zero (0). In this implementation, if a 3×3 region consists of white pixels with one black pixel in the center position, the filter of Table 2 for example will produce its maximum value. That maximum value will be 4*255 or 1020.

Some implementations may choose an edge threshold that is a percentage of the maximum value of the filter. For example, the threshold may be set to four (4), five (5), six (6), seven (7), or eight (8) percent of the maximum value of the filter. In an implementation utilizing the Laplacian filter of Table 2, a threshold may be set to, for example, 61.2, which is six percent of the maximum value of 1020. By increasing the threshold as a percentage of the maximum value of the filter, more error diffusion will be used for edges in the image. By reducing the threshold as a percentage of the maximum value of the filter, random noise dithering will be used in some regions that include edges that would have been dithered with FSE if the higher threshold were used. While error diffusion may sharpen edges, it may also introduce directional artifacts if applied to a region with edges. Thus, careful tuning of the edge threshold may determine the best balance between these factors.

Once decision block 1620 has determined that a measurement of the edge strength of the region is above the edge threshold, process 1600 moves to processing block 1625 and an output pixel is generated by quantizing the input pixel and diffusing the error. However, if the strength of the edges within a region near the input pixel is below the edge threshold, the region near the input pixel is sufficiently uniform so as to be susceptible to display artifacts if error diffusion is applied. Therefore, process 1600 moves to processing block 1630, where an output pixel is generated by adding a noise component to the input pixel. In some implementations, the noise component may be selected by application of a dither mask to the input pixel. In other implementations, the noise component may be chosen directly or indirectly by use of a random number generator. Block 1630 may be implemented by instructions included in the host software 1030, operating system module 1040, display control firmware 1020 or display controller 60 illustrated in FIG. 10. Therefore, these instructions executing on a processor may represent one way to generate an output pixel by dithering the input pixel by adding a noise component to the input pixel.

Process 1600 then moves from either processing block 1630 or processing block 1625 to decision block 1640. Decision block 1640 determines whether there are more pixels from the plurality of pixels received in block 1610 remaining to be processed. If there are more pixels, process 1600 returns to block 1612 and a new pixel is selected and process 1600 repeats block 1612 through block 1640. Otherwise, if there are no more pixels remaining, process 1600 then moves to end block 1650.

The size and shape of the region near the input pixel may vary by implementation. Some implementations may utilize a region that is a square with sides of three pixels by three pixels, for a total of nine pixels. The regions may be defined to be larger. For example, some implementations can use a square region with sides of five pixels by five pixels for a total of 25 pixels, while in other implementations a square region of seven pixels by seven pixels is used, for a region with a total of 49 pixels. In some implementations, only some of the pixels within the boundary of a region are considered.

Other implementations may utilize regions that are substantially circular. For example, some regions may have a radius of two, three, four, five, six, seven, eight, nine, or ten pixels. Other implementations may utilize regions that are rectangular. The longest side of the rectangle may be three, four, five, six, seven, eight, nine, or ten pixels long depending on the implementation.

Other implementations may determine the size of the region based on the size of the input image. For example, some implementations may utilize a region that includes no more than one percent of the pixel area of the input image. Other implementations may define a region that includes no more than five percent of the pixels in the input image. Some implementations may define the size of the dimensions of a square or rectangular region as a percentage of the dimensions of the input image. For example, one dimension of a rectangular region may be no more than five percent of the same dimension of the input image. Similarly, the other dimension of the rectangular region may also be no more than five percent of the corresponding dimension of the input image. Other implementations may define regions to have dimensions corresponding to a certain percentage of the corresponding dimension of the input image (e.g., 1%, 2%, 3%, 4%, 5%, etc.).

In some implementations a region that surrounds the input pixel on all sides is considered associated with or near the input pixel. In other implementations, a region that is centered on the input pixel is considered as being associated with or near the input pixel. This region may be considered to substantially surround the input pixel. For example, in a three pixel by three pixel square region, the input pixel may be centered in the square. Other implementations may not center the input pixel in the region. For example, when half-toning pixels in the vicinity of the edge of an input image, some implementations may shift the region relative to the input pixel to maintain the size of the region without shifting the region beyond the borders of the input image, or the region can be truncated so that the region does not extend past borders of the input image. Such a region may be considered to substantially surround the input pixel, even though it may not surround the pixel on all sides, especially if the pixel is located at the edge or border of an image.

In some implementations, pixels within a region associated with or near the input pixel are within a certain number of pixels from the input pixel. In some implementations, each of a plurality of pixels in the region of the input image can be within 13 pixels or less of the input pixel. Examples of such implementations include, but are not limited to, regions with a plurality of pixels within 11 pixels, 7 pixels, 5 pixels, or 3 pixels from the input pixel.

Note that the size and shape of regions associated with or near an input pixel, along with their position relative to the input pixel, may vary across multiple input pixels of an image. For example, the size and shape of the region for input pixels in the center of an input image may vary from the size and shape of a region associated with or near input pixels along the edge of the input image. Similarly, the input pixels position relative to its associated region may also vary. For example, some input pixels may be centered in their associated regions. Other input pixels may be relatively positioned at one edge of a region, for example, this may be the case with input pixels located on the edge of an input image.

FIG. 16D is a flowchart of one implementation of a method for rendering an image. Process 1658 may be performed in one implementation by instructions contained in operating system module 1040, host software module 1030, display controller 60, or display control firmware module 1020 of FIG. 10. Process 1658 begins at start block 1660. In block 1662, an input image is received. The input image includes a plurality of pixels. In block 1664, a pixel is selected from the plurality of pixels in the input image received in block 1662. In block 1666, a quantization error that would result from application of an error diffusion process on the input pixel is determined.

In some implementations, the quantization error may be determined by subtracting the pixel value from a quantization level. For example, in two bpp quantization, there may be four quantization levels as illustrated in FIG. 16C. The quantization levels are 1649a (0), 1649b (85), 1649c (170), and 1649d (255). In an implementation using these quantization levels, a quantization error may be determined in block 1666 by first calculating the absolute values of the differences between the input pixel value and each quantization level. The minimum of these absolute values may be the quantization error.

In decision block 1668, the quantization error determined in block 1666 is compared to a quantization error threshold. If the error is not less than the quantization error threshold, process 1658 moves to block 1670. In some implementations, determining whether a quantization error resulting from an application of an error diffusion process is greater than an error diffusion error threshold also determines whether the input pixel is within a sparse tonal range.

As described with respect to FIG. 16A, a sparse tonal range may extend in each direction from each quantization level. In process 1658, the quantization error threshold defines the size of the sparse tonal range. Therefore, the quantization error threshold may be based on a percentage of the input image bit depth. If, as discussed with respect to FIG. 16A, the sparse tonal range is about four (4) percent of the maximum pixel value, the sparse tonal range may be 10 pixel values. To implement a sparse tonal range of 10 pixel values around each quantization level, the quantization error threshold may be set to 5. Note that in some implementations, the quantization error is determined based on the absolute value of the difference between the input pixel value and the quantization level.

Similar to FIG. 16A, quantization to one bpp may cause the quantization error threshold to be based on a different percentage of the maximum pixel value. For example, a higher percentage may be used when compared to two bpp quantization.

In block 1670, the edge strength of a pixel region associated with the input pixel is measured. In some implementations, the pixel region associated with the input pixel may be a group of at least four contiguous or non-contiguous pixels within the image. In some other implementations, the pixel region associated with the input pixel may include pixels within a threshold distance of the input pixel. Some variations in the shape or position of regions associated with input pixels may occur. For example, a pixel located close to the edge of the image may have an associated region that is shaped so as to not extend beyond the image edge. In some implementations, these pixel regions may include additional pixels from other sides of the region to maintain an equivalent number of pixels in each pixel's associated region. In other implementations, regions associated with input pixels of the image may not all include the same number of pixels.

In some implementations, the strength of the edges may be determined based, at least in part, on the output of a Laplacian filter. For example, a 3×3 Laplacian filter may be used. Other Laplacian filter sizes may also be used, for example, 5×5, 7×7, and 9×9 filters may be used. If the output of the filter is above an edge threshold, the pixel region considered by the Laplacian filter is considered to include edge components sufficient to avoid image artifacts if error diffusion is used.

Decision block 1672 determines whether the edge strength measurement is greater than an edge threshold. If a region of pixels associated with the input pixel has strong edge components, it may not be susceptible to image artifacts caused by an error diffusion process. In this case, process 1658 transitions to processing block 1678. If the edge strength measurement is not greater than an edge threshold, the region associated with the input pixel may be susceptible to image artifacts if the pixels within the region are dithered using an error diffusion process. In this case, process 1658 transitions to block 1674 where an output pixel is generated by adding a noise component to the input pixel.

Adding a random noise component to the input pixel may be performed by dithering the input pixel with a mask. In these implementations, a dither mask may include random noise components. Depending on which element of the dither mask is applied to a particular input pixel, the noise component added to each pixel may vary. Some other implementations may generate a noise component for each pixel by use of a random number generator. The results of the random number generator may be mathematically tailored to conform to a noise profile. For example, the noise profile may replicate the noise profile that may be provided by a mask in some other implementations.

As discussed, if decision block 1668 determines that the quantization error is less than a quantization error threshold, or decision block 1672 determines that an edge strength measurement is greater than an edge threshold, then process 1658 moves to processing block 1678. In block 1678, an output pixel is generated by applying the error diffusion process to the input pixel and diffusing the error. In some implementations, the error diffusion process applied in block 1678 may utilize the quantization levels relied upon in block 1666. For example, in the two bpp example discussed above, a Floyd Steinberg error diffusion process may be applied in block 1678. Other error diffusion processes are also contemplated. For example, Stevenson Arce dithering may also be used.

Decision block 1676 determines whether more pixels are available for processing. In some implementations, all of the pixels of the input image may be processed by process 1658. In other implementations, only a portion of the pixels in the image may be processed. For example, in some implementations, pixels close to the edge of an image may not be processed by process 1658. When all appropriate pixels have been processed, process 1658 ends at end block 1680.

FIG. 16E is a flowchart of one implementation of a method for rendering an image. Process 1655 may be performed in one implementation by instructions contained in operating system module 1040, host software module 1030, display controller 60, or display control firmware module 1020 of FIG. 10. Process 1655 begins at start block 1682. In block 1684, an input pixel is selected from an image. In block 1686, a first halftoning process is applied to an input pixel to compute a first halftone pixel. The first halftoning process may be Floyd Steinberg error diffusion in some implementations. In other implementations, the first halftoning process may be a noise based dithering process. For example, noise may be added to the input pixel by use of a dither mask in some implementations. In processing block 1688, a second halftoning process is applied to the input pixel to compute a second halftone pixel. Similar to block 1686, the second halftoning process may be FSE or noise based dithering. In one implementation, blocks 1686 and 1688 may be implemented by instructions included in host software module 1030, operating system 1040, display controller 60, or display control firmware 1020, illustrated in FIG. 10. Therefore, these instructions, executing on a processor such as processor 56 illustrated in FIG. 10, represents one way to apply a first or second halftoning process on an input pixel to compute a halftone pixel.

In some implementations, the first halftoning process and the second halftoning process are different. Note that although block 1688 is illustrated after block 1686, no particular order regarding applying a first and second halftone process to generate a first and second halftone pixel should be implied. For example, in some other implementations, block 1688 may occur before block 1686. In still other implementations, block 1686 and block 1688 may occur substantially in parallel.

In block 1690, one of the first and second halftone pixels is selected to generate an output pixel based on local image content in a neighborhood of the respective input pixel. In some implementations, the neighborhood of the respective input pixel substantially surrounds the input pixel and includes pixels adjacent to the input pixel. In some implementations, the neighborhood of the respective input pixel includes the input pixel itself. Block 1690 may also be implemented by instructions in host software module 1030 or operating system 1040, display controller 60 or display control firmware 1020. Therefore, these instructions, executing on a processor, such as processor 56, may represent one way to select one of the first and second halftone pixels to generate an output pixel based on local image content in a neighborhood of a respective input pixel.

In block 1692, it is determined whether there are more pixels to select from the image. If not, process 1655 moves to block 1694 and can end processing for the image. If there are more pixels, process 1655 returns to block 1684.

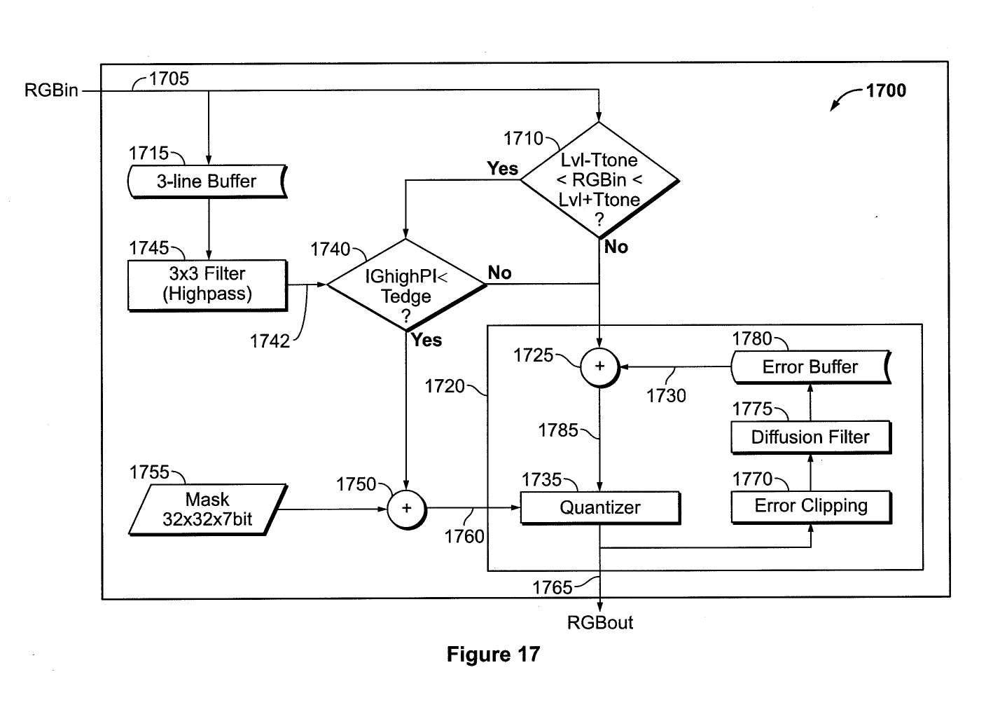

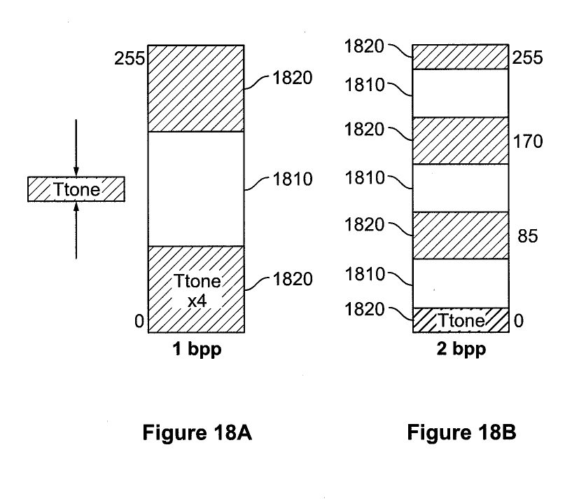

FIG. 17 shows a flowchart illustrating another implementation of hybrid halftoning. Process 1700 may be implemented by instructions in operating system 1040, host program 1030, or display controller firmware 1020, illustrated in FIG. 10. Process 1700 starts with an input pixel value 1705 that has a color depth defined by an RGB color space. The RGB input pixel value 1705 is sent both to decision block 1710 and three line buffer 1715. At decision block 1710, the tone level of the RGB pixel is compared against a tonal range. To illustrate tonal ranges, FIGS. 18A-B will be briefly discussed below.

FIGS. 18A-B illustrate examples of tonal ranges for sparse halftone dot zones 1820 for implementations of (a) one bpp and (b) two bpp, respectively, in some implementations. The proposed method illustrated in FIG. 17 determines if the input pixel belongs to a tonal range defined by a threshold, Tₜₒₙₑ. For example, this may be performed in decision block 1710 of FIG. 17. Tₜₒₙₑ is determined such that the tone-levels delimited by Tₜₒₙₑ produce sparse halftone textures 1820. Tₜₒₙₑ values of approximately ten (10) work well for most images. Sparse tone-levels are susceptible to worm artifacts with FSE. Note that in FIG. 18A, the one bpp case has a four times larger sparse dot zone 1820 than the two bpp case illustrated in FIG. 18B, as it has four times larger quantization intervals. The larger sparse dot zone makes a dithered one bpp image more susceptible generally to worm artifacts than a two bpp image.

Returning to FIG. 17, if the input tone does not belong to any of the sparse dot zones 1820, illustrated in FIG. 18A, and thus will not produce a sparse halftone texture, no further examination of the input pixel value is needed, because the tone of the input pixel does not make it susceptible to visual artifacts if error diffusion is used. Therefore, process 1700 moves to error diffusion block 1720. The input pixel value is added with an error diffusion signal 1730 in adder 1725. The new value is then quantized in quantization block 1735, and the quantized pixel value 1765 is output.

If however, the input pixel value is within a tonal range such as the dark zones 1820 of FIG. 18A, process 1700 moves from decision block 1710 to decision block 1740. In some implementations, the tonal range may only include tonal values that result in a quantization error below a threshold. For example, when quantizing an eight bit per pixel image to a one bit per pixel image, as illustrated in FIG. 18A, input pixel values between zero (0) and 128 may be set to zero in the output image, while input pixel/tone values between 129-256 may be quantized to a value of one (1). In this example, as an input pixel value approaches zero, the quantization error produced when that input pixel is quantized is reduced. Similarly, as an input pixel value approaches 255, the quantization error resulting from quantizing that input pixel value is also reduced. Small quantization errors may result in sparse halftone textures. Tonal ranges with quantization errors below a threshold are illustrated as the dark regions 1820 of FIG. 18A. Therefore, the tonal range referenced in decision block 1710 may therefore be an input pixel value range that results in a quantization error below a threshold.

Decision block 1740 also receives as input a region of pixels 1742 that are “associated with” or “near” input pixel 1705. This region of pixels may pass through a three line buffer 1715 and a 3×3 high pass filter 1745. In some implementations, the 3×3 high pass filter 1745 includes a 3×3 Laplacian filter 1745, which is utilized to compute the amount of edge components surrounding the input pixel and compare its output to a threshold, T_{edge}.

Decision block 1740 then identifies whether a region associated with or near input pixel 1705 includes spatial features. In one implementation, this is determined based on the strength of the edges within the region of the input pixel. The strength of the edges within the region is then compared to a threshold T_{edge} in decision block 1740. If the filter output is less than T_{edge}, the local area is not only a low dot density zone but also somewhat uniform. This indicates the local area may be susceptible to artifacts caused by traditional error diffusion. In this case, process 1700 moves to adder 1750, where the input pixel value 1705 is dithered using adder 1750 and a dither mask 1755. The dithered value 1760 is sent to quantizer 1735, where the dithered value 1760 is quantized and then sent as RGB output 1765. Note that while FIG. 17 illustrates an implementation that utilizes a dither mask 1755 to add noise to an input pixel, use of a dither mask is not required to perform the methods or implement the apparatus disclosed herein. For example, other implementations may add noise to an input pixel by generating a random noise component for each input pixel.

If at decision block 1740, it is determined that the number of edge components in the region associated with or near pixel value 1710 is above the threshold T_{edge}, the value of input pixel 1710 is sent from decision block 1740 to error diffusion block 1720, as error diffusion renders details much better than mask-based dithering when the region is non-uniform. Moreover, if the local area has features, any directional patterns that occur will be less visible even though the pixel belongs to a sparse halftone texture zone.

Within error diffusion block 1720 is quantizer 1735. Quantizer 1735 receives input 1785 when standard error diffusion is used. Quantizer 1735 receives input 1760 when mask based dithering is used. When receiving input 1760, the output of quantizer 1765 is Oₘ(x,y). When receiving input 1785, the output of quantizer 1735 is Oₑ(x,y).

Quantizer output 1765 is then used to calculate quantization error, which is distributed over the error diffusion path, including error clipping block 1770, diffusion filter 1775, and error buffer 1780. In this way, valid quantization error is continuously distributed regardless of the halftoning method being used (noise-based dithering or error diffusion) and hence, boundary effects due to different halftoning methods are reduced.

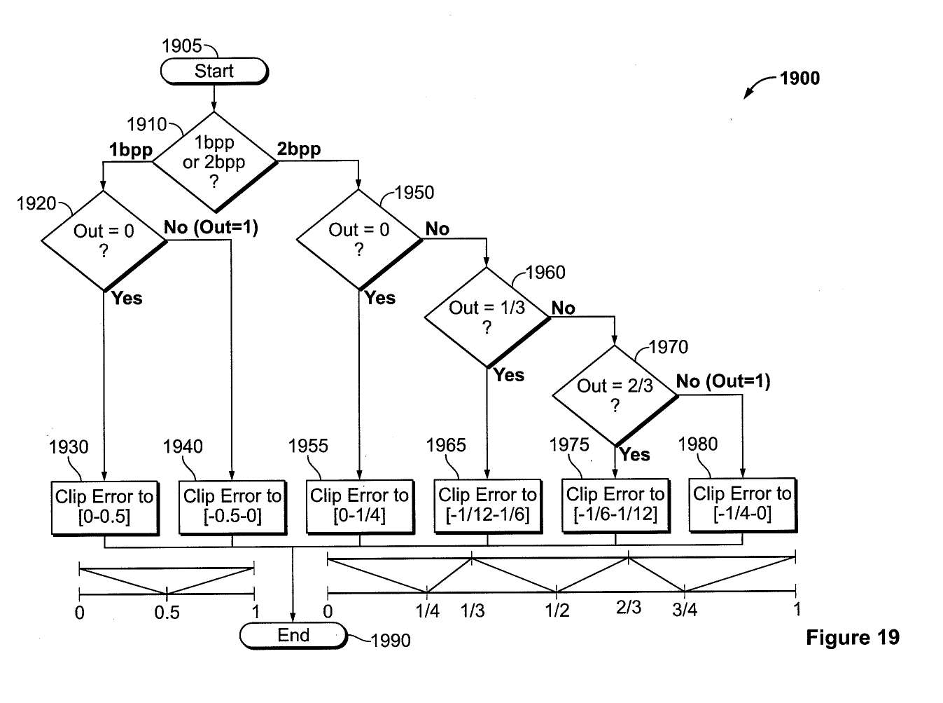

FIG. 19 shows one implementation of an error clipping scheme that supports bi-level halftoning (1 bpp output) and multi-level halftoning (2 bpp output). In some implementations, error clipping process 1900 may be implemented by instructions contained in operating system 1030, host program 1040, or display controller firmware 1020 illustrated in FIG. 10. The error clipping scheme illustrated in FIG. 19 may be implemented in block 1770 of FIG. 17 in some implementations. As its name implies, block 1770 clips quantization error into a desired error range. In some error diffusion methods, quantization error can be bounded. For instance, in bi-level error diffusion with an output of either 0 (black) or 1 (white) and a threshold of 0.5, the range of quantization error is bounded between −0.5 to 0.5. When the quantization error approaches these bounds in these error diffusion methods, the methods force the error to move in the opposite direction (towards the opposite threshold or bound). As explained below however, in the proposed hybrid halftoning method the quantization error may exceed these boundaries.

This effect is illustrated with an example. First, the example assumes that the current quantization error is 0.4 in bi-level halftoning. After tone and local area analysis, it is further assumed that mask halftoning is selected for the current pixel. Mask-based halftoning adds a noise signal to the current pixel. The addition of this noise signal may result in significantly larger quantization errors than those experienced with traditional FSE methods, where the quantization error is bounded by the bit depth of the input signal divided by the number of quantization intervals. When the pixel value resulting from the addition of the noise is quantized, the resulting quantization error may be large. This large quantization error is then accumulated and may be added to subsequent pixels if traditional FSE methods were used to distribute the error. If further large noise signals are added to subsequent pixels, further accumulation of quantization error may occur, resulting in severe visible artifacts such as color bleed, large pixel clusters, etc. To avoid this problem, some implementations of hybrid halftoning includes an error clipping process to bound the quantization error that is carried forward and distributed to subsequent input pixels. One implementation of the error clipping process is discussed below with reference to FIG. 19.

Process 1900 of FIG. 19 starts at start block 1905 and then moves to decision block 1910 where it determines whether it is clipping one bpp values or two bpp values. If process 1900 is handling one bpp data, process 1900 move from decision block 1910 to decision block 1920, where the output bit is compared to zero. If the output bit is not zero, process 1900 moves to processing block 1940 where the error is clipped to between −0.5 and 0.0. If the output bit is zero, process 1900 moves to processing block 1930, where the error is clipped to between zero and 0.5.

If process 1900 is processing two bpp data, process 1900 moves from decision block 1910 to decision block 1950 where the output pixel is compared to zero. If the output pixel is zero, process 1900 moves from decision block 1950 to processing block 1955, where the error is clipped to between 0.0 and 0.25. If the output bit is not zero, process 1900 moves from decision block 1950 to decision block 1960, where the output pixel is compared to 1/3 (0x01). If the output bits are set to 1/3, process 1900 moves from decision block 1960 to processing block 1965, where the error is clipped to a value between −1/12 and 1/6. If the output pixel does not equal 1/3, process 1900 moves from decision block 1960 to decision block 1970, where the output pixel is compared to a value of 2/3 (0x10). If the output pixel does equal 2/3, process 1900 moves from decision block 1970 to processing block 1975, where the error is clipped to a value between −1/6 and 1/12. If the output pixel does not equal 2/3, process 1900 moves to processing block 1980 where the error is clipped to a value between −1/4 and 0. Process 1900 then moves to end state 1990. The error clipping method illustrated in FIG. 19 can be easily generalized for higher bit depths.

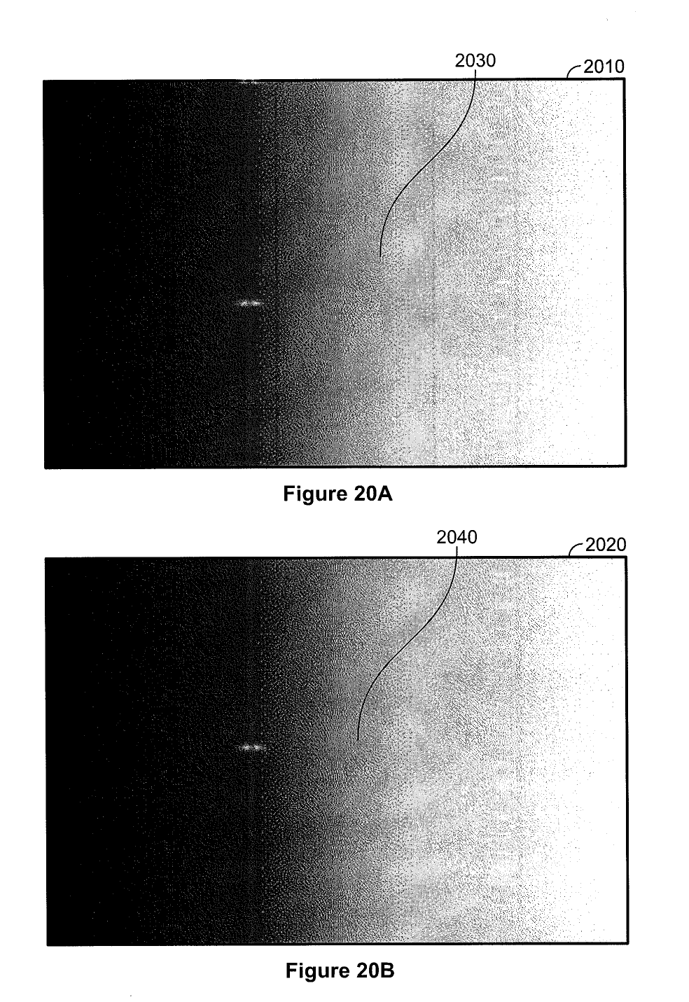

FIG. 20A and FIG. 20B show the benefit of error clipping. FIG. 20A includes image 2010, which is a halftone image without error clipping. FIG. 20B shows image 2020, which is a halftone image with error clipping. A visible banding effect 2030 in the image 2010 halftone without error clipping can be observed, while the corresponding area in image 2040 of FIG. 20B is improved when the error clipping is utilized.

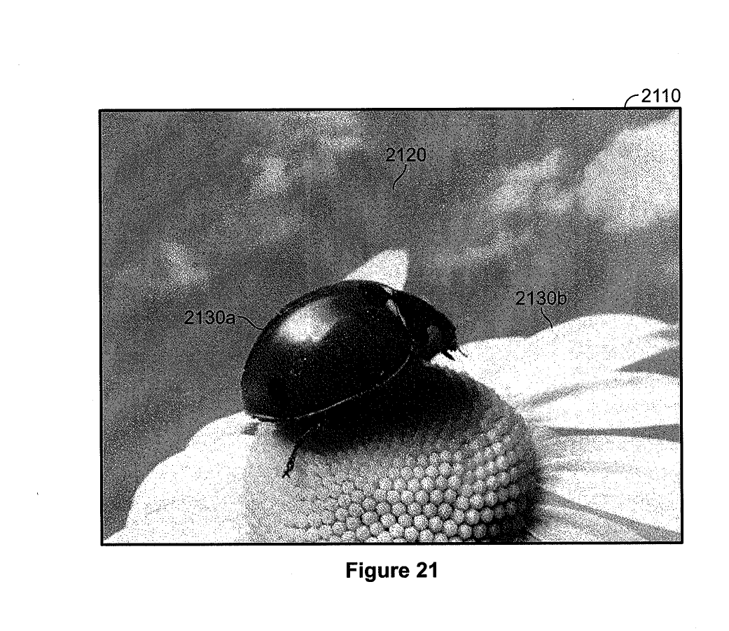

FIG. 21 shows a halftone image 2110 generated by reducing the 24 bpp (8:8:8) image in FIG. 9A with hybrid halftoning. The image exhibits well preserved edges 2130a-b and the textures of the image are smooth and fine. However, unlike the results when using only Floyd Steinberg Error Diffusion, the sparse, uniform regions of the sky 2120 also exhibit good visual appearance.

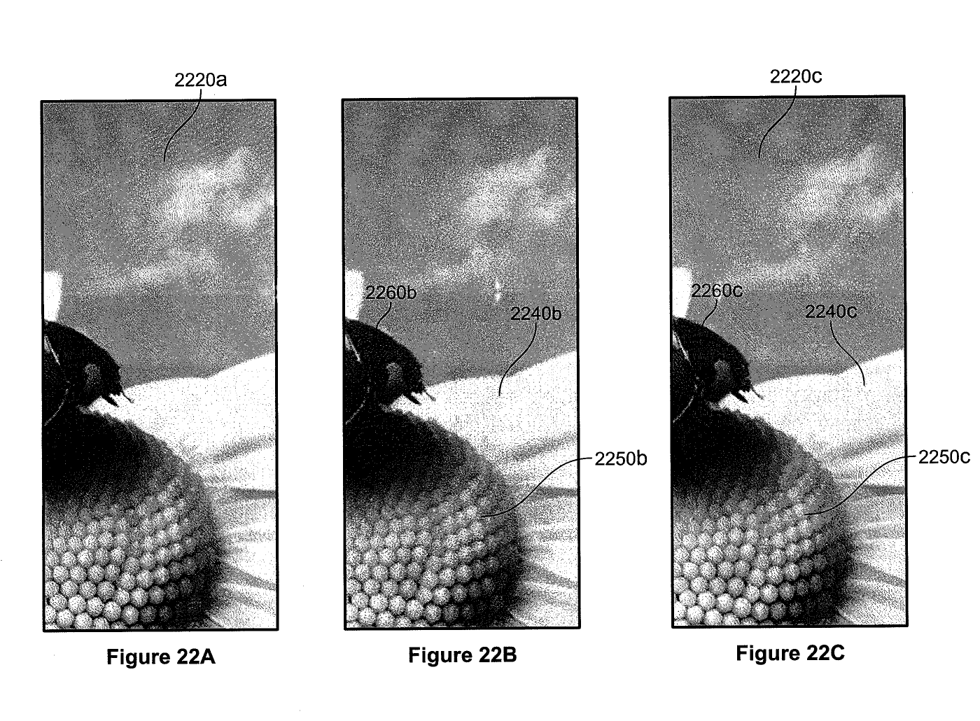

FIGS. 22A-22C illustrate cropped regions of images obtained with FSE (a), noise-based dithering using a dither mask (b), and hybrid halftoning (c), respectively. The result of the hybrid halftoning method renders the background (sky) with a much more uniform pattern 2220c compared to the wormy background 2220a resulting from FSE. Also, the result of hybrid halftoning shows much less noisy textures than the halftone from the mask-based dithering (note particularly the petal 2240b and 2240c, a center part of the flower 2250b and 2250c, and ladybug 2260b and 2260c). The background error diffusion and smart error clipping reduce visible boundary artifacts of hybrid halftoning despite switches between error diffusion and mask based dithering based on local image content.

The performance of hybrid halftoning for video sequences with FSE and mask-based dithering have been compared. FSE, in general, suffers from “boiling” in stationary uniform background scenes due to uncorrelated halftone textures along temporal axis; that is same object has different halftone patterns over time. This boiling may appear as flickering in stationary objects due to variations in the error diffusion of each consecutive frame. Mask-based dithering, on the other hand, generates a more stable video sequence, but still suffers from lower quality rendering. Hybrid halftoning delivers the highest quality video sequence by utilizing error diffusion for the majority of the dithering but switches to mask-based dithering whenever faced with an image area susceptible to boiling, for example, a uniform background with certain tone levels.

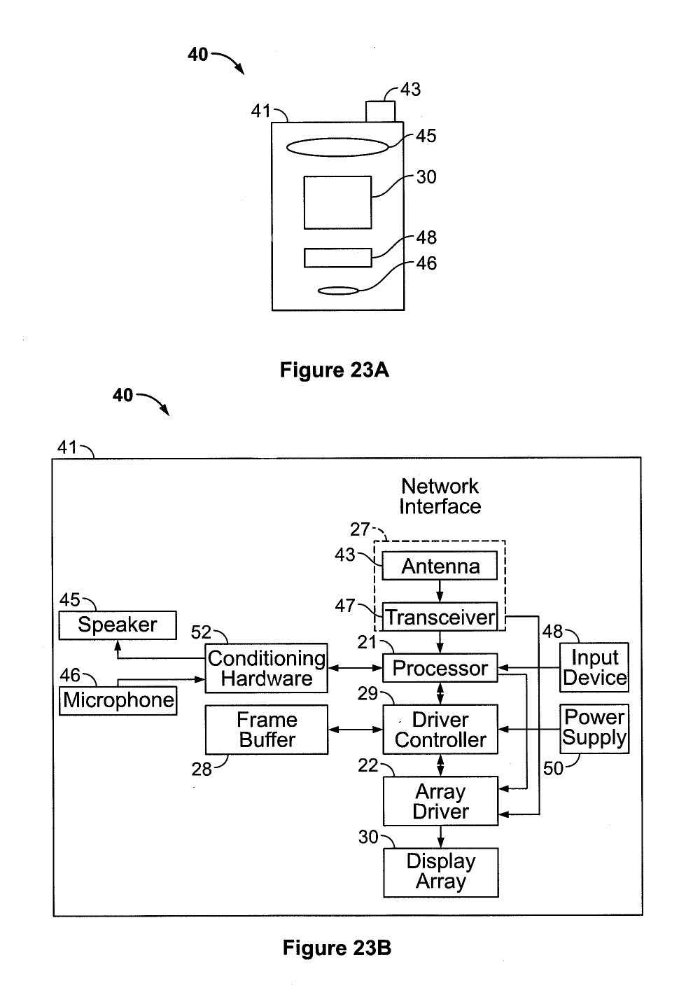

FIGS. 23A and 23B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 23B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to some or all of the components of the particular display device 40 design.

The network interface 27 includes the antenna 43 and the transceiver 47 so that the display device 40 can communicate with one or more devices over a network. The network interface 27 also may have some processing capabilities to relieve, e.g., data processing performed by the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of rendering an image on a display, the method comprising:
receiving an input image including a plurality of input pixels;
for at least a portion of the plurality of input pixels,
determining a quantization error resulting from application of an error diffusion process on the input pixel;
if the quantization error is less than a quantization error threshold, or if an edge strength measurement of a pixel region associated with the input pixel is greater than an edge threshold,
generating an output pixel by applying the error diffusion process to the input pixel and diffusing the quantization error, otherwise,
generating an output pixel by dithering the input pixel by adding a noise component to the input pixel.

2. The method of claim 1, further comprising adding a dithering error resulting from dithering the input pixel by adding the noise component to the input pixel to an error diffusion filter, wherein diffusing the quantization error resulting from quantization of the input pixel is based on the error diffusion filter.

3. The method of claim 1, wherein quantization errors above the quantization error threshold indicate a non-sparse texture and quantization errors below the quantization error threshold indicate a sparse texture.

4. The method of claim 4, wherein the quantization error threshold is based, at least in part, on a percentage of the input image bit depth.

5. The method of claim 4, wherein the quantization error threshold is between about two percent and three percent of the maximum value of the input pixel.

6. The method of claim 1, wherein the edge strength measurement filters the region with a Laplacian filter.

7. The method of claim 6, wherein the edge threshold is about six percent of the maximum value of the Laplacian filter.

8. The method of claim 1, wherein the error diffusion process is Floyd Steinberg error diffusion.

9. The method of claim 2, wherein the dithering error is clipped before adding the dithering error to the diffusion filter.

10. The method of claim 1, wherein the region associated with the input pixel substantially surrounds the input pixel and includes pixels adjacent to the input pixel.

11. The method of claim 1, wherein the dimensions of the region associated the input pixel is five pixels by five pixels.

12. The method of claim 1, wherein the dimensions of the region associated the input pixel is seven pixels by seven pixels.

13. The method of claim 1, wherein the region of the input pixel includes less than about one percent of the input pixels in the input image.

14. The method of claim 1, wherein the region associated with the input pixel is centered around the input pixel.

15. The method of claim 1, wherein the region associated with the input pixel includes the input pixels within one, two, three, five, seven, nine, or eleven pixels of the input pixel.

16. The method of claim 1, wherein if the quantization error is less than a quantization error threshold, the input pixel value is considered to be within a sparse tonal range.

17. The method of claim 1, wherein the noise component is added to the input pixel using a dither mask.

18. The method of claim 1, wherein the region associated with the input pixel is a group of at least four contiguous pixels included in the input image.

19. The method of claim 1, wherein the region associated with the input pixel is a group of at least four non-contiguous pixels included in the input image.

20. A method to render an image on a display, comprising:
for at least a portion of a plurality of input pixels of the image,
applying a first halftoning process on a respective input pixel to compute a first halftone pixel,
applying a second halftoning process on the respective input pixel to compute a second halftone pixel, and
selecting one of the first and the second halftone pixels to generate an output pixel based on local image content in a neighborhood of the respective input pixel.

21. The method of claim 20 wherein the first halftoning process is mask-based dithering and the second halftoning process is error diffusion.

22. The method of claim 20, wherein the neighborhood of the respective input pixel substantially surrounds the input pixel and includes pixels adjacent to the input pixel.

23. The method of claim 20, wherein the neighborhood of the respective input pixel is a three pixel by three pixel region around the respective input pixel.

24. The method of claim 20, wherein the neighborhood of the respective input pixel is a five pixel by five pixel region around the respective input pixel.

25. The method of claim 20, wherein the neighborhood of the respective input pixel is a seven pixel by seven pixel region around the respective input pixel.

26. The method of claim 20, wherein the neighborhood of the respective input pixel includes the input pixels within one, two, three, five, seven, nine, or eleven pixels of the respective input pixel.

27. A display apparatus, comprising:
an electronic display; and
a display control module, configured to
receive an input image including a plurality of input pixels,
for at least a portion of the plurality of the input pixels, generate an output pixel by
determining a quantization error resulting from application of an error diffusion process on the input pixel,
if the quantization error is less than a quantization error threshold, or if an edge strength measurement of a pixel region associated with the input pixel is greater than an edge threshold,
generating an output pixel by applying the error diffusion process to the input pixel and diffusing the quantization error,
otherwise, generate an output pixel by dithering the input pixel by adding a noise component to the input pixel, and
render each of the generated output pixels on the electronic display to form a displayed halftone image.

28. The apparatus of claim 27, wherein the display control module is further configured to add a dithering error resulting from dithering the input pixel by adding the noise component to an error diffusion filter, wherein diffusing the quantization error resulting from quantization of the input pixel is based on the error diffusion filter.

29. The apparatus of claim 27, wherein the edge strength measurement filters the region with a Laplacian filter.

30. The apparatus of claim 27, wherein the region associated with the input pixel substantially surrounds the input pixel and includes pixels adjacent to the input pixel.

31. The apparatus of claim 27, wherein the region associated with the input pixel is the input pixels within one, two, three, five, seven, nine, or eleven pixels of the input pixel.

32. The apparatus of claim 27, wherein the noise component is added to the input pixel using a dither mask.

33. The apparatus of claim 27, wherein the region associated with the input pixel is a group of at least four contiguous pixels included in the input image.

34. The apparatus of claim 27, wherein the region associated with the input pixel is a group of at least four non-contiguous pixels included in the input image.

35. The apparatus of claim 27, further comprising:
a display;
a processor that is configured to communicate with the display, the processor being configured to process image data; and
a memory device that is configured to communicate with the processor.

36. The apparatus as recited in claim 35, further comprising a driver circuit configured to send at least one signal to the display.

37. The apparatus as recited in claim 36, further comprising a controller configured to send at least a portion of the image data to the driver circuit.

38. The apparatus as recited in claim 35, further comprising an image source module configured to send the image data to the processor.

39. The apparatus as recited in claim 38, wherein the image source module includes at least one of a receiver, transceiver, and transmitter.

40. The apparatus as recited in claim 35, further comprising an input device configured to receive input data and to communicate the input data to the processor.

41. A display apparatus, comprising:
means for receiving an input image including a plurality of input pixels;
for at least a portion of the plurality of input pixels,
means for determining a quantization error resulting from application of an error diffusion process on the input pixel;
means for generating an output pixel by applying the error diffusion process to the input pixel and diffusing the quantization error if the quantization error is less than a quantization error threshold, or if an edge strength measurement of a pixel region associated with the input pixel is greater than an edge threshold; and
means for generating an output pixel by dithering the input pixel by adding a noise component to the input pixel if the quantization error is greater than the quantization error threshold or the edge strength measurement is less than the edge threshold.

42. The display apparatus of claim 41, wherein the region associated with the input pixel substantially surrounds the input pixel and includes pixels adjacent to the input pixel.

43. The apparatus of claim 41, wherein the noise component is added to the input pixel using a dither mask.

44. The apparatus of claim 41, wherein the region associated with the input pixel is a group of at least four contiguous pixels included in the input image.

45. The apparatus of claim 41, wherein the region associated with the input pixel is a group of at least four non-contiguous pixels included in the input image.

46. A display apparatus, comprising:
for at least a portion of a plurality of input pixels of the image,
means for applying a first halftoning process on a respective input pixel to compute a first halftone pixel,
means for applying a second halftoning process on the respective input pixel to compute a second halftone pixel, and
means for selecting one of the first and the second halftone pixels to generate an output pixel based on local image content in a neighborhood of the respective input pixel.

47. The apparatus of claim 46, wherein the means for applying a first halftoning process includes a display controller implementing Floyd Steinberg error diffusion.

48. The apparatus of claim 46, wherein the means for applying a second halftoning process includes a display controller implementing mask based dithering.

49. The apparatus of claim 46, wherein the means for selecting one of the first and the second halftone-pixels to generate an output pixel is a switch implemented by a display controller that analyzes the input tone as well as spatial frequency content of its local area to determine whether to select the first or second halftone pixels.

50. The apparatus of claim 46, wherein the neighborhood of the respective input pixel substantially surrounds the input pixel and includes pixels adjacent to the input pixel.

51. A non-transitory, computer readable storage medium having instructions stored thereon that cause a processing circuit to perform a method comprising:
receiving an input image including a plurality of input pixels;
for at least a portion of the plurality of input pixels,
determining a quantization error resulting from application of an error diffusion process on the input pixel;
if the quantization error is less than a quantization error threshold, or if an edge strength measurement of a pixel region associated with the input pixel is greater than an edge threshold,
generating an output pixel by applying the error diffusion process to the input pixel and diffusing the quantization error, otherwise,
generating an output pixel by dithering the input pixel by adding a noise component to the input pixel.

52. The computer readable medium of claim 51, wherein the region associated with the input pixel substantially surrounds the input pixel and includes pixels adjacent to the input pixel.

53. The computer readable medium of claim 51, wherein the method further includes adding a dithering error resulting from dithering the input pixel with the mask to an error diffusion filter, wherein diffusing the error resulting from quantization of the input pixel is based on the error diffusion filter.

54. The computer readable medium of claim 51, wherein quantization errors above the quantization error threshold indicate a non-sparse texture and quantization errors below the quantization error threshold indicate a sparse texture.

55. The computer readable medium of claim 51, wherein the error diffusion process includes Floyd Steinberg error diffusion.

56. The computer readable medium of claim 51, wherein the dithering error is clipped before adding the error to the diffusion filter.

57. The computer readable medium of claim 51, wherein the noise component is added to the input pixel using a dither mask.

58. The computer readable medium of claim 51, wherein the region associated with the input pixel is a group of at least four contiguous pixels included in the input image.

59. The computer readable medium of claim 51, wherein the region associated with the input pixel is a group of at least four non-contiguous pixels included in the input image.
